(19) United States
(12) Patent Application Publication
(10) Pub. No.: US 2024/0143854 A1
(43) Pub. Date: May 2, 2024

(54) METHOD AND SYSTEM FOR CONFIGURING AN INDUSTRIAL GAS PLANT COMPLEX POWERED BY RENEWABLE POWER SOURCES

(71) Applicant: Air Products and Chemicals, Inc., Allentown, PA (US)

(72) Inventors: Sanjay Mehta, Orefield, PA (US); Pratik Misra, Breinigsville, PA (US)

(73) Assignee: Air Products and Chemicals, Inc., Allentown, PA (US)

(21) Appl. No.: 17/975,707

(22) Filed: Oct. 28, 2022

(51) Int. Cl. G06F 30/13

(52) U.S. Cl. CPC G06F 30/13

(57) ABSTRACT

A method and system for selecting a design configuration of an industrial gas plant complex comprising one or more industrial gas plants and powered by one or more renewable power sources.

### TECHNICAL FIELD

The present invention relates to a method and system for configuring an industrial gas plant complex superstructure powered by renewable power sources. More particularly, the present invention relates to a method and system for selecting a design configuration of an industrial gas plant complex superstructure comprising one or more industrial gas plants and one or more renewable power sources for powering the industrial gas plants.

### BACKGROUND

An industrial gas plant complex comprises one or more industrial process plants which produce, or are involved in the production of, gases. In non-limiting examples, these gases may comprise: industrial gases, commercial gases, medical gases, inorganic gases, organic gases, fuel gases and green fuel gases either in gaseous, liquified or compressed form.

There is considerable interest in methods and systems for utilising renewable energy sources for powering industrial gas plants and industrial gas plant complexes. However, a significant drawback of the use of renewable energy sources such as wind, solar and tidal power is the natural variability and transient nature of such energy sources.

In general, a constant or substantially constant power supply is preferred for an industrial gas plant or industrial gas plant complex. Therefore, the variable and intermittent nature of wind, solar and/or tidal power is problematic and renders it difficult to design an industrial gas plant complex which can efficiently, safely and cost-effectively utilize such power sources whilst operating at a commercially-viable capacity.

An exemplary industrial gas is hydrogen. Hydrogen is generally produced from electrolysis of water. A further exemplary industrial gas is ammonia. Ammonia is produced using hydrogen from water electrolysis and nitrogen separated from the air. These gases are then fed into the Haber-Bosch process, where hydrogen and nitrogen are reacted together at high temperatures and pressures to produce ammonia.

There is considerable interest in the production of hydrogen and/or ammonia using renewable energy. These gases are known as green hydrogen and green ammonia. However, both hydrogen and ammonia production can be sensitive to the variable energy availability and in order for such production plants to be efficient, safe, cost-effective and economically-viable, careful design of such production plants is required. Design of a hydrogen or ammonia production plant operable to run on renewable energy sources is a complex and multi-factorial problem which poses significant challenges for infrastructure designers and industrial businesses.

Thus, solutions to these technical problems are required to enable industrial gases to be produced efficiently from renewable power sources.

### BRIEF SUMMARY OF THE INVENTION

The following introduces a selection of concepts in a simplified form in order to provide a foundational understanding of some aspects of the present disclosure. The following is not an extensive overview of the disclosure, and is not intended to identify key or critical elements of the disclosure or to delineate the scope of the disclosure. The following merely summarizes some of the concepts of the disclosure as a prelude to the more detailed description provided thereafter.

Disclosed herein are methods and systems (also referred to herein as “computer-implemented methods and systems) for selecting a design configuration of an industrial gas plant complex comprising one or more industrial gas plants and powered by one or more renewable power sources.

Several preferred aspects of the methods and systems according to the present invention are outlined below.

Aspect 1: A method of configuring an industrial gas production complex superstructure comprising one or more plant subsystems and being powered at least in part by one or more renewable power subsystems, the method being executed by at least one hardware processor and comprising: providing a model of the industrial gas production complex superstructure having a plurality of selectable configurations representative of potential configurations of the industrial gas production complex superstructure; specifying, in the model, a plurality of selectable modelled renewable power subsystems, each modelled renewable power subsystem having predicted time series power profile data for a predetermined time period associated therewith; specifying, in the model, a plurality of selectable modelled plant subsystems, each selectable modelled plant subsystem having a plurality of selectable modelled components associated therewith; associating a plurality of operational parameters and a plurality of operational constraints with each of the plurality of modelled renewable power subsystems, with each of the plurality of modelled plant subsystems and with the each of the plurality of selectable modelled components; selecting a plurality of configurations of the model by selecting, for each configuration: one or more modelled renewable power subsystems; one or more modelled plant subsystems; and one or more components associated with the selected one or more modelled plant subsystems; determining, for each selected configuration, the predicted operation of the selected configuration of an industrial gas production complex superstructure over a predetermined time period to determine a maximum value of a predetermined operational output parameter for the selected configuration and for the predetermined time period, the predicted operation utilizing the power profile data associated with the one or more selected renewable power subsystems and the operational parameters and operational constraints associated with the selected configuration; utilizing a surrogate model to identify, based on the operational output parameter data and the selected configuration data for each configuration, one or more configurations of the industrial gas production complex superstructure operable to maximize the value of the operational output parameter whilst meeting the predefined operational constraints; and generating one or more designs for the industrial gas production complex superstructure based on the identified one or more configurations.

Aspect 2: A method according to aspect 1, wherein the plurality of selectable modelled renewable power subsystems is arranged in groups of: wind farm subsystems, solar farm subsystem, tidal power subsystems and hydroelectric power subsystems.

Aspect 3: A method according to aspect 2, wherein within each of said groups a plurality of selectable modelled renewable power subsystems are available to be selected, each selectable modelled renewable power subsystem sharing the same profile of the predicted time series power profile data but varying in the magnitude of the available maximum power.

Aspect 3A: A method according to aspect 2, wherein the plurality of selectable modelled renewable power subsystems within each group vary in time-averaged maximum output power, the predicted time series power profile data being scaled in accordance with the time-averaged maximum output power.

Aspect 3B: A method according to aspect 2 or 3, wherein the plurality of selectable modelled renewable power subsystems are each associated with an operational constraint of available physical size of the subsystem being modelled, the magnitude of the available maximum power being scaled with the available physical size.

Aspect 3C: A method according to aspect 3B, wherein within each group available physical size varies for each subsystem in the group.

Aspect 4: A method according to aspect 2 or 3, wherein a plurality of selectable modelled renewable power subsystems may be selected from at least two different groups.

Aspect 5: A method according to any one of aspects 1, 2, 3 or 4, wherein the plurality of selectable modelled plant subsystems is arranged in groups of: gas production plant subsystems and gas storage subsystems.

Aspect 6: A method according to aspect 5, wherein the gas production plant subsystems comprise one or more of: hydrogen production plant; air separation unit; and ammonia production plant, and wherein the gas storage subsystems comprise one or more of: hydrogen gas storage; hydrogen liquefier; nitrogen storage; and ammonia storage.

Aspect 7: A method according to aspect 6, wherein at least one selected gas production plant subsystem comprises a hydrogen production plant and wherein the selectable modelled components for the hydrogen production plant are selectable from one or more of: electrolyser type; electrolyser capacity; compressor systems; purifier systems.

Aspect 8: A method according to any one of aspects 1 to 7, wherein the operational output parameter comprises the amount of gas produced.

Aspect 8A: A method according to any one of aspects 1 to 8, wherein the predefined operational constraints comprise the predicted available power for the predetermined period.

Aspect 8B: A method according to aspect 8A, wherein the maximized value of the output parameter is achieved whilst minimizing the amount of time in the predetermined period when the power consumption industrial gas complex superstructure exceeds the predicted available power.

Aspect 8C: A method according to aspects 8A and 8B, wherein the predefined operational constraints comprise efficiency, safety, and regulatory constraints.

Aspect 9: A method according to any one of aspects 1 to 8, further comprising: constructing an industrial gas production complex superstructure according to the design.

Aspect 10: A system for configuring an industrial gas production complex superstructure comprising one or more plant subsystems and being powered at least in part by one or more renewable power subsystems, the system comprising: at least one hardware processor; a subsystem module operable to: provide a model of the industrial gas production complex superstructure having a plurality of selectable configurations representative of potential configurations of the industrial gas production complex superstructure; specify a plurality of selectable modelled renewable power subsystems, each modelled renewable power subsystem having predicted time series power profile data for a predetermined time period associated therewith; and specify a plurality of selectable modelled plant subsystems, each selectable modelled plant subsystem having a plurality of selectable modelled components associated therewith; a simulation module operable to: associate a plurality of operational parameters and a plurality of operational constraints with each of the plurality of modelled renewable power subsystems, with each of the plurality of modelled plant subsystems and with the each of the plurality of selectable modelled components; select a plurality of configurations by selecting, for each configuration: one or more modelled renewable power subsystems; one or more modelled plant subsystems; and one or more components associated with the selected one or more modelled plant subsystems; and determine, for each selected configuration, the predicted operation of the selected configuration of an industrial gas production complex superstructure over a predetermined time period to determine a maximum value of a predetermined operational output parameter for the selected configuration and for the predetermined time period, the predicted operation utilizing the power profile data associated with the one or more selected renewable power subsystems and the operational parameters and operational constraints associated with the selected configuration; and an optimization module operable to: utilize a surrogate model to identify, based on the operational output parameter data and the selected configuration data for each configuration, one or more configurations of the industrial gas production complex superstructure operable to maximize the value of the operational output parameter whilst meeting the predefined operational constraints; and generate one or more designs for the industrial gas production complex superstructure based on the identified one or more configurations.

Aspect 11: A system according to aspect 10, wherein the plurality of selectable modelled renewable power subsystems is arranged in groups of: wind farm subsystems, solar farm subsystem, tidal power subsystems and hydroelectric power subsystems.

Aspect 12: A system according to aspect 11, wherein within each of said groups a plurality of selectable modelled renewable power subsystems are available to be selected, each selectable modelled renewable power subsystem sharing the same profile of the predicted time series power profile data but varying in the magnitude of the available maximum power.

Aspect 13: A system according to aspect 11 or 12, wherein a plurality of selectable modelled renewable power subsystems may be selected from at least two different groups.

Aspect 14: A system according to any one of aspects 10 to 13, wherein the plurality of selectable modelled plant subsystems is arranged in groups of: gas production plant subsystems and gas storage subsystems.

Aspect 15: A system according to any one of aspects 11 to 14, wherein the gas production plant subsystems comprise one or more of: hydrogen production plant; air separation unit; and ammonia production plant, and wherein the gas storage subsystems comprise one or more of: hydrogen gas storage; hydrogen liquefier; nitrogen storage; and ammonia storage.

Aspect 16: A system according to aspect 15, wherein at least one selected gas production plant subsystem comprises a hydrogen production plant and wherein the selectable modelled components for the hydrogen production plant are selectable from one or more of: electrolyser type; electrolyser capacity; compressor systems; purifier systems.

Aspect 17: A system according to any one of aspects 10 to 15, wherein the predetermined operational output parameter comprises the amount of gas produced in the predetermined time period.

Aspect 18: A computer readable storage medium storing a program of instructions executable by a machine to perform a method of controlling an industrial gas production facility comprising one or more industrial gas plants powered by a power network including one or more renewable power sources, the method being executed by at least one hardware processor, the method comprising: providing a model of the industrial gas production complex superstructure having a plurality of selectable configurations representative of potential configurations of the industrial gas production complex superstructure; specifying, in the model, a plurality of selectable modelled renewable power subsystems, each modelled renewable power subsystem having predicted time series power profile data for a predetermined time period associated therewith; specifying, in the model, a plurality of selectable modelled plant subsystems, each selectable modelled plant subsystem having a plurality of selectable modelled components associated therewith; associating a plurality of operational parameters and a plurality of operational constraints with each of the plurality of modelled renewable power subsystems, with each of the plurality of modelled plant subsystems and with the each of the plurality of selectable modelled components; selecting a plurality of configurations of the model by selecting, for each configuration: one or more modelled renewable power subsystems; one or more modelled plant subsystems; and one or more components associated with the selected one or more modelled plant subsystems; determining, for each selected configuration, the predicted operation of the selected configuration of an industrial gas production complex superstructure over a predetermined time period to determine a maximum value of a predetermined operational output parameter for the selected configuration and for the predetermined time period, the predicted operation utilizing the power profile data associated with the one or more selected renewable power subsystems and the operational parameters and operational constraints associated with the selected configuration; utilizing a surrogate model to identify, based on the operational output parameter data and the selected configuration data for each configuration, one or more configurations of the industrial gas production complex superstructure operable to maximize the value of the operational output parameter whilst meeting the predefined operational constraints; and generating one or more designs for the industrial gas production complex superstructure based on the identified one or more configurations.

Aspect 19: A computer readable storage medium according to aspect 18, wherein the plurality of selectable modelled renewable power subsystems is arranged in groups of: wind farm subsystems, solar farm subsystem, tidal power subsystems and hydroelectric power subsystems.

Aspect 20: A computer readable storage medium according to aspect 19, wherein within each of said groups a plurality of selectable modelled renewable power subsystems are available to be selected, each selectable modelled renewable power subsystem sharing the same profile of the predicted time series power profile data but varying in the magnitude of the available maximum power.

### BRIEF DESCRIPTION OF THE DRAWINGS

Embodiments of the present invention will now be described by example only and with reference to the figures in which:

FIG. 1 is a schematic diagram of an industrial gas plant complex and control system;

FIG. 2 is a schematic diagram of the configuration system of according to an embodiment;

FIG. 3 is a graph showing predicted wind power profiles for the time period of one year;

FIG. 4 is a graph showing predicted solar power profiles for the time period of one year; and

FIG. 5 is a flow chart of a method according to an embodiment.

Embodiments of the present disclosure and their advantages are best understood by referring to the detailed description that follows. It should be appreciated that like reference numbers are used to identify like elements illustrated in one or more of the figures, wherein showings therein are for purposes of illustrating embodiments of the present disclosure and not for purposes of limiting the same.

### DETAILED DESCRIPTION

Various examples and embodiments of the present disclosure will now be described. The following description provides specific details for a thorough understanding and enabling description of these examples. One of ordinary skill in the relevant art will understand, however, that one or more embodiments described herein may be practiced without many of these details. Likewise, one skilled in the relevant art will also understand that one or more embodiments of the present disclosure can include other features and/or functions not described in detail herein. Additionally, some well-known structures or functions may not be shown or described in detail below, so as to avoid unnecessarily obscuring the relevant description.

The present invention relates to a method and system for selecting a design configuration of an industrial gas plant complex superstructure comprising one or more industrial gas plants for producing one or more industrial gases and one or more renewable power sources for powering the industrial gas plant complex.

In non-limiting embodiments, the industrial gas plant complex may comprise a hydrogen production plant and/or an ammonia production plant powered by renewable energy sources. However, the present invention has applicability to other types of industrial gas plant complex. For example, the present invention has applicability to air separation plants for production of nitrogen from the atmosphere.

General Configuration of Industrial Gas Plant Complex

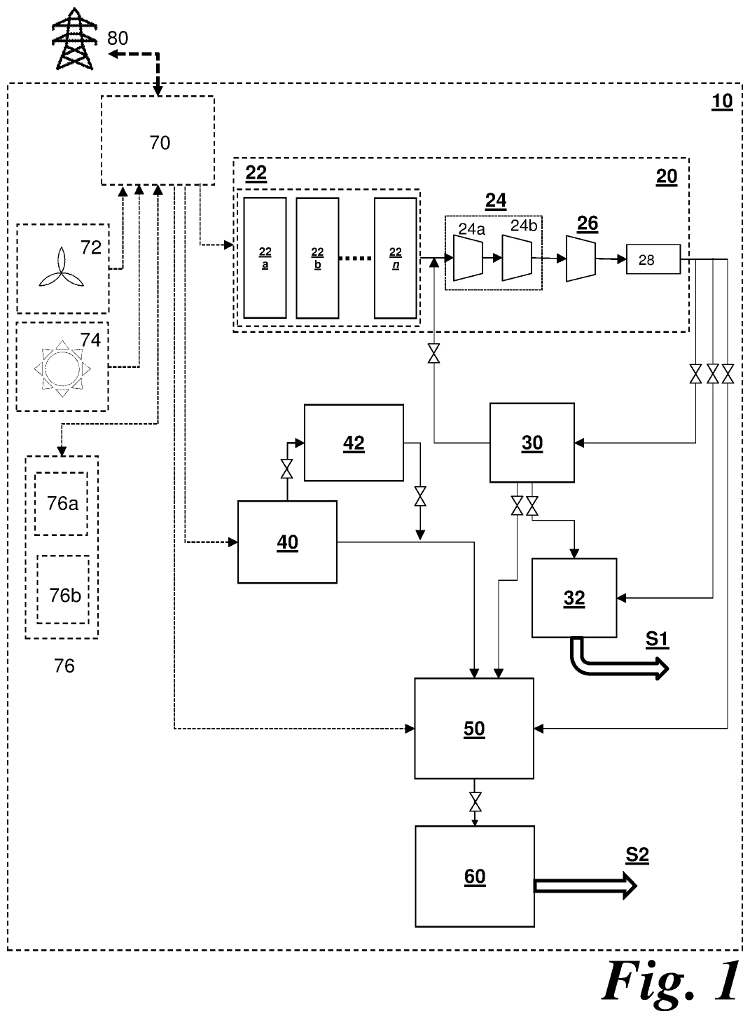

The components of an exemplary industrial gas plant complex superstructure will now be described with reference to FIG. 1. The method and system of the present invention is operable to design and/or configure the respective elements of the industrial gas plant complex in order to achieve an optimized and/or maximized configuration or design to achieve a desired capacity given the available power resources in a specific region and the desired operational characteristics of the industrial gas plant complex.

FIG. 1 shows a schematic diagram of an exemplary industrial gas plant complex superstructure 10 which can be designed and/or configured in accordance with embodiments of the present invention.

In this embodiment, the industrial gas plant complex comprises an ammonia plant complex 10. However, this is to be taken as exemplary and non-limiting. Other types of industrial gas plant complex superstructure may be designed and/or configured with the disclosed embodiments of the present invention; for example, a hydrogen production plant, a nitrogen production plant or other industrial gas production facilities.

The Industrial gas plant complex 10 comprises a hydrogen production plant 20, a hydrogen storage unit 30, a hydrogen liquefier 32, an Air Separation Unit (ASU) 40, an ammonia synthesis plant 50 and an ammonia storage unit 60. The hydrogen liquefier 32 is connected to an external supply chain S1 for onward distribution of liquid hydrogen. The ammonia storage unit 60 is connected to an external supply chain S2 for onward distribution of ammonia.

The industrial gas plant complex superstructure 10 further comprises power resources in in the form of a main bus 70, renewable power sources 72, 74 and energy storage resources 76. The industrial gas production components of the Industrial gas plant complex 10 will now be described in detail.

Hydrogen Production Plant 20

The hydrogen production plant 20 is operable to electrolyse water to form hydrogen and oxygen. Any suitable source of water may be used. However, in embodiments in which sea water is used to produce the water for the electrolysis, the apparatus would further comprise at least one desalination and demineralisation plant for processing the sea water.

The hydrogen production plant 20 comprises a plurality of electrolysis units 22a, 22b . . . 22n or electrolysis cells. Each unit or cell may be referred to as an “electrolyser” 22a, 22b . . . 22n. Any number of electrolysers may be provided. In embodiments, around 100 may be provided. The electrolysers may enable the hydrogen production plant 20 to have a total capacity of the order of 1 GW. In embodiments, the capacity may be in excess of 2 GW; for example, 2.2 GW. However, the ultimate capacity of the hydrogen production plant 20 is limited only by practical considerations such as power supply. Any suitable capacity may be used depending upon design requirements.

Any suitable type of electrolyser may be used. In embodiments, the plurality of electrolysers usually consists of a multiplicity of individual cells combined into “modules” that also include process equipment such as pumps, coolers, and/or separators. Hundreds of cells may be used and may be grouped in separate buildings. Each module typically has a maximum capacity greater than 10 MW, although this is not intended to be limiting.

Any suitable type of electrolyser may be used. Generally, three conventional types of electrolyser are utilized—alkaline electrolysers; PEM electrolysers; and solid oxide electrolysers. Any of these types may be used with the present invention.

Alkaline electrolysers transport hydroxide ions (OH⁻) through the electrolyte from the cathode to the anode with hydrogen being generated on the cathode side. Commonly, a liquid alkaline solution of sodium hydroxide or potassium hydroxide is used as the electrolyte.

A PEM electrolyser utilizes a solid plastics material as an electrolyte, and water reacts at an anode to form oxygen and positively charged hydrogen ions. The electrons flow through an external circuit and the hydrogen ions selectively move across the PEM to the cathode. At the cathode, hydrogen ions combine with electrons from the external circuit to form hydrogen gas.

Solid oxide electrolysers use a solid ceramic material as the electrolyte that selectively conducts negatively charged oxygen ions (O²⁻) at elevated temperatures. Water at the cathode combines with electrons from the external circuit to form hydrogen gas and negatively charged oxygen ions. The oxygen ions pass through the solid ceramic membrane and react at the anode to form oxygen gas and generate electrons for the external circuit.

The electrolysers may be arranged in any suitable group. For example, they may be arranged in parallel.

Hydrogen is produced at about atmospheric pressure by the hydrogen production plant 20. A stream of hydrogen so generated is removed from the electrolysers at a slightly elevated pressure. However, this need not be the case and hydrogen may be produced at much greater pressures as required. This may, in embodiments, eliminate the need for some or all downstream compressor systems.

In embodiments, the hydrogen production plant 20 further comprises hydrogen compression and purification stages.

In embodiments, the compression stage comprises a multistage compression system having two sections 24, 26. The first section 24 comprises a low pressure (LP) section in which hydrogen gas is compressed from a first feed pressure from the electrolysers to a second intermediate pressure greater than the first feed pressure.

The second section comprises a medium pressure (MP) section 26 in which the hydrogen gas is compressed from the second intermediate pressure to a third final pressure greater than the second pressure. The third pressure is selected as required for any downstream process(es).

In the non-limiting embodiment shown in FIG. 1, the first (LP) section 24 has two compressor stages 24a, 24b. However, any suitable number may be used. For example, the LP section 24 may have a single compressor or may have a plurality of compressors.

As shown in the non-limiting embodiment of FIG. 1, the second (MP) section 26 is shown as a single compressor arrangement for brevity. However, any suitable number of parallel trains and/or stages of compression may be provided as required. For example, a plurality of trains may be provided in parallel, with each train comprising a plurality of compression stages.

The compressors forming part of the first (LP) 24 and second (MP) 26 compression sections may take any suitable form. The person skilled in the art would readily be aware of the form, number and capacity of these compressors. For example, for a total electrolyser capacity of 1 GW, 2 to 4 compressors would typically be required. 5 or more may be required for total electrolyser capacity of 2GW.

The compressors used may also be selected as appropriate for the operational capacity and type of gas production plant. For example, for hydrogen applications, the LP section 24 may comprise one or more centrifugal compressors, whilst the MR section 26 may comprise one or more reciprocating compressors. However, this is not intended to be limiting and any suitable compression arrangements may be used as appropriate

In the embodiment of FIG. 1, a purification section 28 is provided. The purification section 28 may be required where, for example, any downstream processes require higher purity hydrogen (i.e. with reduced levels of water and/or oxygen inherently present in the compressed hydrogen gas produced by the electrolysis). However, this need not be the case and this section may be omitted if not required.

If provided, the purification section 28 comprises a “DeOxo” unit operable to remove oxygen. The DeOxo unit operates through the catalytic combustion of hydrogen to produce water compressed hydrogen gas from which oxygen has been removed.

The purification section 28 may further comprise a drier. In this embodiment, the drier comprises a temperature swing adsorption (TSA) unit to produce dry compressed hydrogen gas for the downstream process(es). However, other suitable drier and/or adsorption technologies may be used here. In embodiments, the drier is downstream of the DeOxo unit.

A downstream processing unit may be any unit that utilises hydrogen gas as a feedstock or as a resource. In embodiments, the downstream processing unit is or includes an ammonia synthesis plant. An alternative or further downstream processing unit may be a hydrogen liquefier as described below.

Hydrogen Storage Unit 30

Hydrogen may be stored in the hydrogen storage unit 30. The storage unit 30 may comprise of a plurality of short-term and longer-term storage options with different sizes, filling/discharge rates, and roundtrip efficiencies.

Typical storage system could include pressure vessels and/or pipe segments connected to a common inlet/outlet header. The pressure vessels may be spheres, for example, to about 25 m in diameter, or “bullets” which are horizontal vessels with large UD ratios (typically up to about 12:1) with diameters up to about 12 m. In certain geographies, underground caverns may be included as storage systems to flatten out the seasonal variations associated with the renewable power.

The hydrogen storage 30 is connected downstream of the hydrogen production plant 20 in a storage loop. An inlet supply line to the hydrogen storage 30 extends from the outlet header of the purification section 28 of the hydrogen production plant 20 to the hydrogen storage 30, and a return supply line extends from the hydrogen storage 30 to the output header downstream of the electrolysers 22 and upstream of the compression sections 24, 26. Valves are located in the inlet and return supply lines to control selectively the flow of gas to/from the hydrogen storage 30.

Hydrogen storage 30 is in general required as a buffer in view of the variability of renewable power. If, for example, the renewable power availability is low (e.g. during hours of darkness or low wind), then it may not be possible to run the electrolysers of the hydrogen production plant 20 at full capacity or potentially at all. In order to maintain a flow of hydrogen to downstream processes, stored hydrogen can be mobilised.

The capacity of hydrogen storage (or indeed storage of any gas) needs to be configured and specified in accordance with practical requirements. Gas storage may take up considerable space within an industrial gas production complex 10 and require significant capital expenditure.

So, whilst in an ideal situation, sufficient gas storage would be provided to ensure that all periods of expected low renewable power could be covered by stored gas resources, physical, practical and capital expenditure constraints place practical limits on the size and capacity of available gas resources. This means that, in a practical context, the finite size of gas resources must be factored in when considering the method and system of the present invention.

In the context of the present embodiments, stored hydrogen may be used as a reservoir for ammonia synthesis plant 50.

Hydrogen Liquefier 32

Additionally or alternatively to the use of hydrogen for ammonia synthesis in the ammonia synthesis plant 50, generated hydrogen may be liquified for onward distribution into a supply network S1.

Typically, hydrogen liquefaction involves some degree of initial compression using a compression system, followed by cryogenic cooling using one or more heat exchangers to around 30K. An expansion step may then take place in an expander. The gas is then passed through a separator before being stored or transferred to the onward supply chain S1.

Air Separation Unit 40

In non-limiting embodiments, the nitrogen gas required for ammonia production is produced by cryogenic distillation of air in the air separation unit (ASU) 40. Typically an ASU 40 has various stages operating at different pressures. For example, a high pressure (HP) Column operates at around 10.5 bar g and a low pressure (LP) Column operates at around 5 bar g. Gaseous nitrogen is produced by the ASU 40 at pressures in excess of 25 bar g. The pressure is then reduced to provide a stream of nitrogen gas in one or more pipes arranged to transport nitrogen to the ammonia synthesis plant 50. However, other nitrogen sources may be used if required, for example, liquid nitrogen storage 42.

Liquid nitrogen storage unit 42 may comprise any suitable Liquid Nitrogen Storage, Vaporisation and Distribution (LIN SVD) arrangement. The storage unit 42 may comprise a plurality of short-term and longer-term storage options having different sizes, filling/discharge rates, and roundtrip efficiencies.

A typical storage system for liquid nitrogen may comprise a plurality of pressure vessels and/or pipe segments connected to a common inlet/outlet header. The pressure vessels may comprise low pressure flat bottom storage tanks (FBTs). Additionally or alternatively, the pressure vessels may be spheres, for example, to about 25 m in diameter, or “bullets” which are horizontal vessels with large L/D ratios (typically up to about 12:1) with diameters up to about 12 m.

As described above in relation to the hydrogen storage resource 30, the nitrogen storage 42 is required to be configured and specified in accordance with practical requirements. Gas storage may take up considerable space within an industrial gas production complex 10 and require significant capital expenditure.

So, whilst in an ideal situation, sufficient gas storage would be provided to ensure that all periods of expected low renewable power could be covered by stored gas resources, physical, practical and capital expenditure constraints place practical limits on the size and capacity of available gas resources. This means that, in a practical context, the finite size of gas resources must be factored in when considering the method and system of the present invention.

Preferably, the nitrogen gas produced by the ASU 40 is compressed by a compressor and cooled to be stored in the nitrogen storage unit 42 in liquid form. However, gaseous nitrogen storage may also be provided. The storage unit 42 may be used as a reservoir for ammonia synthesis plant 50 which may be fed by a connecting pipe.

Ammonia Synthesis Plant 50

The ammonia synthesis plant 50 operates on the Haber-Bosch process and comprises an ammonia loop. An ammonia loop is a single unit equilibrium reactive system which processes the synthesis gases of nitrogen and hydrogen to produce ammonia.

Nitrogen is provided by one or more pipes from the ASU 40 (or storage 42) which, in embodiments, may run continuously to provide nitrogen. Hydrogen is provided from one or more pipes from hydrogen production plant 20 either directly (if it is running based on the availability of the renewable power at given instance) or from the hydrogen storage 30.

Stoichiometric composition of synthesis gas is processed by a syn-gas compressor system (not shown) and the resulting ammonia product is refrigerated by another set of compressors (not shown) and sent to storage 60 if required. The performance of ammonia loop is governed by the equilibrium conversion of the exothermic reaction. The parameters for this will be discussed below.

Industrial Gas Production Complex Power Supply

Electricity for powering the industrial gas plant complex superstructure 10 is provided by a main bus 70. The main bus 70 forms part of the industrial gas plant complex superstructure 10 and may be located on site.

Renewable power sources 72, 74 feed electricity into the main bus 70 for onward distribution to subsystems of the industrial gas plant complex superstructure 10. This is shown schematically in FIG. 1 through dotted arrows.

The renewable energy sources comprise wind energy sources 72 (via a suitable wind farm comprising a plurality of wind turbines) and/or solar energy sources 74 (via a solar farm comprising a plurality of solar cells) although other forms of renewable energy may also be utilized (for example, tidal or hydroelectric power sources). The renewable energy sources 72, 74 form part of the industrial gas complex superstructure 10. Whilst wind and solar are shown and described, other forms of renewable energy generation may be provided as part of the superstructure 10.

To address the intermittency of power supply from renewable sources 72, 74, the industrial gas production complex 10 comprises an energy storage resource 76. In embodiments, the energy storage resource 76 is located on-site and forms part of the superstructure of the industrial gas production complex 10.

The energy storage resource 76 may comprise one or more energy storage devices. In embodiments, the energy storage resource 76 forms part of the industrial gas plant complex 10 and is controlled and managed thereby as will be described below.

The energy storage resource 76 may take any suitable form. In embodiments, the energy storage devices may comprise one or more of: a Battery Energy Storage System (BESS) 76a or a Compressed/Liquid Air Energy Systems (CAES or LAES) 76b.

A BESS 76a utilises electrochemical techniques and may comprise one or more of: lithium ion batteries, lead acid batteries, zinc bromine, sodium sulphur or redox flow batteries. Electro-chemical arrangements such as batteries have advantages in terms of fast charging rates and fast (virtually instantaneous) ramp rates to supply power to cope with a sudden drop in energy supply. However, such devices tend to be of more limited power capacity than other systems. Therefore, they may be better suited for use in situations where, for example, a power shortfall from renewable sources is expected to be temporary or short in duration.

A CAES 76b compresses air and stores the air under a high pressure of around 70 bar. It is usually stored in an underground cavern. When power is required, the compressed air is heated and expanded in an expansion turbine in order to drive a generator.

A LAES 76b comprises an air liquefier to draw air from the environment and compress and cool the air to achieve liquefaction. The liquified air is then stored in an insulated tank until power is required. To convert the liquified air into useable energy, the liquid air is pumped to high pressure and heated through heat exchangers. The resulting high-pressure gas is used to drive a turbine to generate electricity.

CAES and LAES are capable of storing significantly more energy than most BESS 76a systems. However, CAES and LAES have slower ramp rates than electro-chemical storage devices and require longer to store larger quantities of energy. For example, it may take of the order of 5-10 minutes for a compression stage to operate under full load, and 10-20 minutes to generate full power on demand. Such storage devices are therefore more appropriate for longer-term storage and for supplying power during long periods of renewable energy shortfall.

Whilst all these elements are shown in FIG. 1, this is for illustrative purposes only. The energy storage resource 76 need not comprise each and every described element and may comprise only one or more of the described elements. In addition, the energy resource 76 may comprise additional elements.

Elements 72, 74, 76 feed into the main bus 70 as shown by the arrows in FIG. 1. Element 76 is operable to supply power to the main bus 70 when demand requires it, and to store energy from the main bus 70 when demand is low. In other words, the energy storage resource 76 acts to smooth the power delivery to the network in view of the variability of renewable energy sources such as wind 72 and solar 74.

The selection of the type, and capacity of the energy storage resource 76 is a further parameter which needs to be considered in the design and configuration of an industrial gas production complex. Available space, capital expenditure, and specific ramp rates of each of the types of energy storage need to be considered in the design process.

Whilst the above examples of renewable power have been given with regard to wind and solar power, this is not intended to be limiting. For example, other renewable energy sources may be used such as hydro-electric (not shown) and/or tidal power (not shown).

The main bus 70 is, as shown in FIG. 1, connected to local power grid infrastructure 80. The local grid infrastructure 80 is outside the scope of the superstructure 10. The industrial gas plant complex superstructure 10 is configured and/or designed to minimise or eliminate the need to rely on external power sources such as the local power grid 80.

However, a supply connection is required as an emergency backup in the event of emergencies or in rare situations where sufficient power from elements 72, 74, 76 is temporarily unavailable and power from external sources such as the local grid infrastructure 80 is required to prevent shutdown of subsystems of the industrial gas plant complex superstructure 10.

Superstructure Design and Configuration Methodology

In embodiments, the present invention relates to a method and system for designing and configuring a superstructure such as an industrial gas plant complex. In embodiments, the industrial gas plant complex comprises an ammonia production plant.

The design of such a superstructure is multifactorial and highly complex. The present invention, in embodiments, seeks to provide a method and system for designing such a superstructure based on technical constraints such as the site location, renewable power availability, performance of the components of the superstructure, utilization rates, safety requirements, efficiency and performance criteria, capital expenditure and desired production rates of industrial gas.

The method and system may in embodiments utilize an optimization approach to define a “configuration space” for an industrial gas plant complex superstructure and seek, within the defined configuration space an improved configuration which achieves the desired production rates within predetermined parameters. In the context of the present invention, an optimization approach aims to identify, within a predetermined configuration space, a configuration or range of configurations which meet specific criteria or parameters in order to achieve specific technical aims.

For example, the optimization approach may be utilized to identify an industrial gas plant complex superstructure which is operable to produce a desired amount (for example, either a maximal amount or an amount above a predefined threshold) of industrial gas (for example, ammonia and/or liquid hydrogen) based upon a preferred input power profile given the actual or potential renewable energy sources available with minimal or no reliance upon external power sources such as a local grid.

For example, the methodology may generate one or more configurations which, for given economic, safety, regulatory and infrastructure constraints and requirements, are able to produce a maximal amount of industrial gas or gases whilst operating within h

In embodiments, the method utilizes a number of technical inputs, which define constraints on the design to be produced. The subsystems defining the design, and their technical parameters, components and relevant constraints define the configuration space within which one or more maximized or optimized configurations can be selected.

The configuration space may be defined by a combination of pre-specified elements and automatically-defined elements. For example, a user may select a particular type of industrial gas plant complex superstructure (for example, a hydrogen production plant or an ammonia production plant) which then requires particular subsystems (e.g. hydrogen production plant subsystem and hydrogen storage subsystem) in order to function in the intended manner.

The user may also specify particular design parameters for the industrial gas complex superstructure which impose further requirements and constraints. For example, a maximum power requirement from renewable sources, or a maximum or minimum desired production output of industrial gas.

Within those user-specified bounds, particular components may be available for selection in the model as required. These may be user-defined or may be automatically defined based on the initial input requirements.

It can therefore be seen that the configuration space is defined (or arises) through a combination of user requirements, component availability and technical parameters and constraints.

A configuration of each subsystem of the industrial gas plant complex superstructure is selected from within the defined configuration space, and a simulation is run on that configuration to determine a maximum production for that configuration utilizing an optimization strategy. The process is repeated for different configurations, and the resulting data used in a surrogate model to determine an optimal configuration.

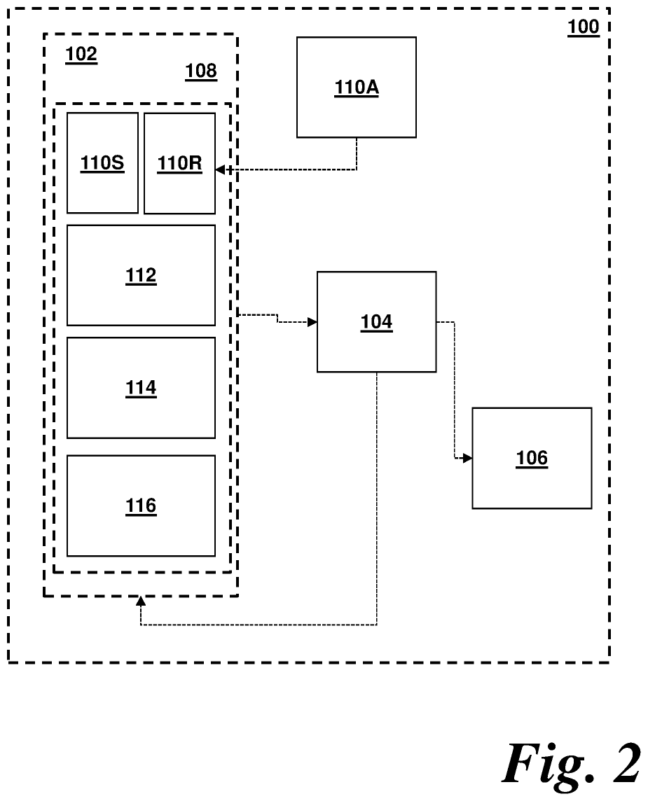

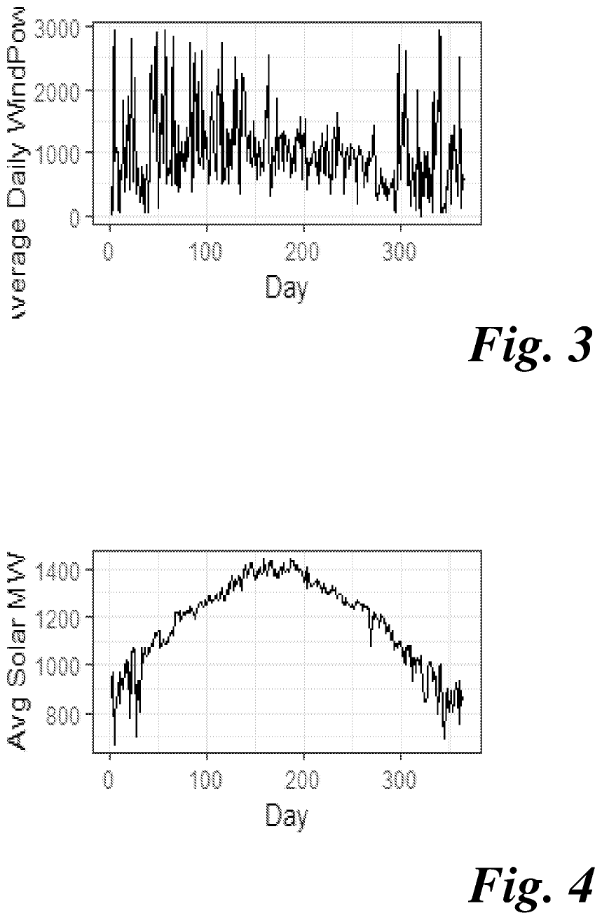

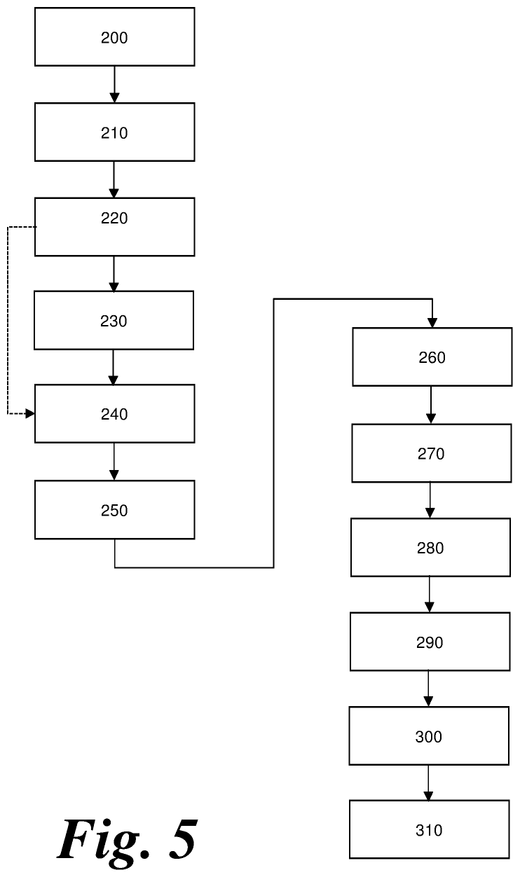

A computer-implemented method and system will now be described. FIG. 2 shows a schematic diagram of a configuration system 100 according to an embodiment. The configuration system 100 comprises a plurality of modules.

The configuration system 100 comprises a subsystem module 102, a simulation module 104 and an optimization module 106. The configuration system 100 is operable to select one or more maximized or optimized configurations of an industrial gas plant complex superstructure in a desired location.

The configuration system 10 is run on computer hardware. For example, the configuration system 100 may use a Central Processing unit (CPU) and/or Graphical Processing Unit (GPU) components of a computer system. In addition, other specialist hardware may be used such as Field Programmable Gate Arrays (FPGAs), Application Specific Integrated Circuits (ASICs) or other stream processor technologies.

Additionally, the model execution computer(s) may optionally be connected to other computer database systems where, for example, weather data services or other external data may be stored.

Subsystem Module 102

The subsystem module 102 enables the infrastructure subsystems forming the industrial plant complex superstructure to be defined and specified. A schematic diagram of the elements of the subsystem module 102 is shown in FIG. 2.

The subsystem module 102 enables specification of the initial model of the industrial gas plant complex superstructure 108 to be configured and designed and enables specification of both one or more power subsystems 110 and one or more plant subsystems 112 therein. Components 114 within each subsystem 110, 112 can then be specified. Constraints 116 can then be applied to the power subsystems 110 and plant subsystems 112, and components 114 of those subsystems 110, 112 within the industrial plant complex superstructure 108.

In other words, the subsystem module 102 defines a configurable model having a plurality of selectable subsystems 110, 112. The subsystems 110, 112 may be selected from a group or pool of available subsystems. Some subsystems may be user-specified and part of the basic design requirements of the industrial gas production complex superstructure (e.g. the type of industrial gas production complex superstructure that is required in terms of gas production or renewable power generation level).

Other subsystems may be optional or selectable from a group of available subsystems during the configuration process. By “available” is meant that a particular subsystem is compatible with or can be used as part of an overall design requirement and is included in the model.

The subsystem module 102 receives data specifying the type and configuration of the subsystems of the industrial gas plant complex superstructure 108 to be designed and configured. This data depends on the nature of the industrial gas plant complex superstructure such as its intended use and configuration (for example, an ammonia or hydrogen production plant).

For each subsystem 110, 112, parameters and components 114 can be selected within particular bounds and constraints 116. The available range of parameters, components 114 and constraints 116 which are specified define the configuration space within which one or more configurations of the industrial gas plant complex superstructure 108 can be selected as will be described below.

The following disclosure illustrates how the specifications and constraints input into the subsystem module 102 enables the industrial gas plant complex superstructure 108 to be configured and designed and the power subsystems 110 and plant subsystems 112 specified within the configuration space so defined.

The detailed disclosure is illustrated with references to an industrial gas plant complex superstructure 108 in the form of an ammonia production plant powered by renewable power sources in the form of wind and solar power generation resources.

Power Subsystems 110

Each power subsystem 110 has particular design parameters. The power subsystems 110 may, in embodiments, be grouped into power generation (e.g. renewable power subsystems 110R), and/or support power infrastructure (e.g. energy storage 76, main bus 70).

Renewable Power Subsystems 110R

Renewable power subsystems 110R may be selected automatically or manually during configuration of the model of the subsystem module 102. For renewable power subsystems 110R, specific components may not be material to the present invention and, in embodiments, the renewable power subsystems 110R may be defined only by parameters and any relevant constraints.

By this is meant that the detailed specification of renewable power subsystem 110R components (for example, the type, number and configuration of wind turbines or solar panels) of one or more renewable power subsystems 110R is not material to the present invention. However, in embodiments, the parameters of each power subsystem 110 can be specified based on particular design and/or configuration requirements.

In embodiments, one or more renewable power subsystems 110R may be selected by a user or automatically. Each renewable power subsystem 110R is grouped by type, e.g. wind, solar, tidal etc. Within each group, a range of renewable power subsystems 110R can be selected having different operational parameters.

The operational parameters may comprise the maximum and minimum power profile of the given renewable power subsystem 110R. How power profiles are derived is explained in the section below in relation to power prediction module 110A. Predicted power profiles comprise, in embodiments, the estimated power produced by a given configuration of renewable power subsystem 110R for a given number of intervals (e.g. 1 hour) over a predetermined period of time (e.g. 1 year). This shows the predicted daily power availability of the given renewable power subsystem 110R

As explained above, each available renewable power subsystem 110R is selectable as an entity with particular operational parameters. In embodiments, no internal components are selectable. However, parameters such as the maximum power generation of a renewable power subsystem 110R may be specified. This allows a selection of a renewable power subsystem 110R having available power generation which is scaled to meet the demands of the industrial gas plant complex superstructure.

Consider an available renewable power subsystem 110R having a maximum available physical size which is capable of a maximum power generation of 2000 MW and having a given power profile. However, for particular industrial gas production complex superstructures such a power output may not be required, or other renewable power sources may be used in combination with the given subsystem 110R meaning that the full 2000 MW capacity is not required.

In such a scenario, the group of selectable renewable power subsystems 110R maybe scaled from the maximum such that a subsystem 110R having reduced maximum power generation such as 1500, 1000 or 500 MW may be selectable. The selection may be continuous (with a renewable power subsystem 110R being selectable with any value below the maximum power generation and above a minimum required power generation) or discrete (e.g. a plurality of different selectable subsystems 110R having discrete maximum power generation values).

In either scenario, in embodiments, the power profile for each subsystem 110R of the same type (e.g. wind/solar) has an identical profile and form but different magnitudes. In other words, if each power profile for each subsystem 110R within a given group is normalised to the maximum available power of each subsystem 110R, the profiles would be effectively identical and overlap.

This selectability may derive from real-world design decisions. For example, it may be that a particular area of land is available for provision of renewable resources (wind and/or solar). If the entirety of the land area is utilized for wind power then that energy resource may generate a particular power profile (the maximum or expected power delivered over a predefined period of time such as a year). This defines an upper bound or constraint on the maximum wind power which could be generated with the available resource. The same applies if the whole of the resource is used for solar power.

However, if only a part of the available resource area is used for wind, for example a minimum commercially or technically viable size of wind farm resource, then this would define a lower bound on the power profile for the wind power resource. However, the power profile would essentially be the same in profile for each size, albeit scaled so that the magnitude is proportional to the selected size of wind farm.

Again, this applies to solar power. Therefore, in this example, it can be seen that a range of parameters for each renewable power subsystem 110R can be defined and used as part of the global superstructure optimization problem to select the appropriate power profile for the desired superstructure configuration.

The defined range (either discrete or continuous) of configurations of available renewable power subsystems 110R which provide specific maximum power generation amounts for given power profiles enables a mix of renewable sources to be investigated and an optimal configuration selected.

For example, the optimization process can utilize data relating to a tailored selection of wind and solar resources. Solar power may provide more consistent power during daylight hours, but wind power may provide more flexibility and power generation during hours of darkness. Thus, a specific mix of these power profiles can be used as part of the configuration selection to identify a maximised power profile for use with a particular configuration of plant subsystems 112.

The maximum and minimum power generation may be constraints and parameters which can be selected. However, other constraints may be assigned as appropriate.

For example, constraints 116 may apply safety considerations in terms of maximum capacity and limitations on power generation, or rate of change of generation to preserve component integrity and safety.

In addition, constraints 116 may also be applied to the renewable power subsystems 110R on longer timeframes; for example, to factor in performance and efficiency degradation over time, or to specify time intervals for repair and replacement of renewable power subsystems.

Constraints 116 may also be applied in relation to the inter-dependency of parameters between renewable power subsystems 110R and plant subsystems 112 of the industrial gas plant complex superstructure 108 to be configured and designed. For example, further constraints may be applied to ensure ramp rates for renewable power subsystems 110R do not exceed those of the technical limitations of the powered plant subsystems 112.

Power Profile Module 110A

Acquisition of power profile information for one or more renewable power subsystems 110R will now be described.

The configuration system 100 further comprises a power profile module 110A to operable to obtain predicted time-dependent operational and meteorological data for the one or more renewable power subsystems 110R for a predetermined period of time. In embodiments, the time period is at least a year, in embodiments this may be multiple years. The time-series data represents the available power from renewable sources as a function of time.

For the purposes of this embodiment, only wind and solar power are considered. However, as described above, this is non-limiting and other renewable sources of power may be used in embodiments.

In embodiments, if the renewable power subsystem(s) 110 under consideration are comparable to an existing renewable power source such as a wind farm or solar farm (or selected part thereof), then the variables of wind power WPi and solar power SPi in time-series data for a predetermined time period may be available to use as predicted data for future estimation and design. In embodiments, the index i represents time from period n to n+k and this data may be available at intervals of fixed duration with the power generated expressed in units of MW as a function of time.

More commonly, if the renewable power site has yet to be designed or built, then the time-series power data can be estimated using suitable metrics and/or models. In embodiments, the time-series power data can be estimated from weather sources and from technical information.

For example, historical and current wind data may be available from publicly-available sources such as https://globalwindatlas.info or NREL. Historical and current solar data may be available from publicly-available sources such as https:globalsolaratlas.info or NREL, and detailed irradiance and albedo data may be available from http://silsolargis.com.

Additionally or alternatively, given the challenges in predicting local wind speeds and variation, local measurements may be obtained by installing, for example, measurement masts in identified sites with one or more anemometers at different height levels. On-site data may be collected for a period of time, for example, a minimum of one year. Additionally or alternatively, modelling simulations may be used to determine the wind profile for an entire wind farm by using historical data to create a wind forecasting model for a specified geographical area.

Technical data may also be used. For wind farms, this may comprise known wind farm layouts and design, selection and number of turbines. For solar farms, technical details such as the type, area, efficiency and number of panels and their location and orientation may be modelled with suitable software.

This data may then be used to generate predicted power profiles over a predetermined period of time. The period of time may be based on historical data (e.g. past wind data for a period of one or more years) or may be based on predicted future data derived from a machine learning process, for example.

The predicted average power data may be used to generate P50 and P90 power profiles for the predetermined time period. P50 represents a median value of the annual estimate of power production from the renewable resource such that over the life of the project the power production at any given time has a 50% probability of falling below the P50 value and a 50% probability of exceeding the P50 value.

The P90 value is more conservative and represents an average power value that will be met or exceeded 90% of the time.

However, whilst P50 and P90 are widely used in the respective industries, any suitable metric may be used. For example, P25, P75, or any other suitable metric.

It is further noted that the data utilized by the power subsystems 110 may be obtained by any suitable means and the above discussion does not limit the power subsystems 110 to any requirement for data generation. Indeed, the data may be provided from an external source.

The average wind power WPi and average solar power SPi may be provided or generated for a time period which, in embodiments, is a year or more. The data may comprise a time series where index i represents time from period n to n+k in intervals of fixed duration. In non-limiting embodiments, the intervals may comprise 15 minutes, 30 minutes or 1 hour.

In embodiments, additional environmental and meteorological signals may be used to refine the determination of average power profiles. These may comprise but are not limited to time-dependent environmental data comprising: air temperature Ti; atmospheric pressure Pi; wind speed WSi; cloud cover CCi; precipitation Pi; humidity Hi; where index i represents time from period n-m to n+k.

The above data may be used to define constraints 116 on the renewable power subsystems 110R, for example site size, scaling, power profiles and capacity. These constraints define a configuration space for the renewable power subsystems 110R from which appropriate configurations can be selected and executed during the simulation stage.

Support Power Subsystems 110S

Support power subsystems 110S comprise power infrastructure elements such as the main bus 70 and the energy storage 76. In embodiments, certain support power subsystems 110S may be specified automatically in response to the selections made in respect of the renewable power subsystems 110R described above; for example, a main bus 70 selected to handle the selected maximum power values resulting from the selection of one or more renewable power subsystems 110R. However, in embodiments, certain elements such as the energy storage 76 may be specified.

In some cases, one or more support power subsystems 110S may comprise one or more components 114. The components 114 correspond to functional elements of the subsystem and are each selectable from a pool of components. Components 114 may be modular and part of the design and configuration process may involve determining the number and size of any one type of component 114.

The subsystem module 102 is further operable to define constraints 116 on the construction and operation of the components 114 within each support power subsystem 110S and between each component 114.

Constraints may include technical constraints in normal operation such as power consumption, maximum and minimum capacities, efficiency, and variation of efficiency with load.

The constraints 116 may also take into account dynamic processes—for example, ramp rates for start-up and shutdown of an energy storage resource. These constraints 116 may also be linked to wider constraints and issues—for example, safety considerations in terms of maximum capacity and limitations on ramp rates to preserve component integrity and safety.

In addition, constraints may also be applied on longer timeframes; for example, to factor in performance and efficiency degradation over time, or to specify time intervals for repair and replacement of battery modules.

Constraints 116 may also be applied in relation to the inter-dependency of parameters between power subsystems 110 (both renewable and support power subsystems 110R, 110S) and plant subsystems 112 of the industrial gas plant complex superstructure 108 to be configured and designed. For example, further constraints may be applied to ensure ramp rates for power subsystems 110 do not exceed those of the technical limitations of the powered plant subsystems 112.

Support Power Subsystem 110S—Energy Storage Resource

A support power subsystem 110S is the energy storage resource selection and configuration. Whilst this feature may be optional, in most renewable systems some form of smoothing or backup power source is required. Selection and configuration parameters are as follows:

Energy storage type: Battery Energy Storage System (BESS) or Compressed/Liquid Air Energy Systems (CAES or LAES).

Energy storage technical parameters: capacity, configuration, construction (e.g. Lithium Ion batteries, Lead acid batteries, Zinc Bromine, Sodium Sulphur or Redox Flow batteries, physical size).

Energy storage operability constraints: (ramp rates, charging rates, rate of change of performance and storage efficiency over time (i.e. ageing and degradation), degradation of charge storage material, mean or averaged time intervals between replacement or repair, mean or average time for repair or replacement of components).

Energy storage safety and regulatory constraints: maximum capacity, maximum power draw, limitations on ramp rates, regulations preventing certain components (e.g. electrolysers) from being powered by energy storage resources alone or at all.

Energy storage inter-dependency considerations (power supplied to specific subsystems only, power management on bus 70).

Support Power Subsystem 110S—Main Bus 70

A support power subsystem 110S which may be selected and configured is the main power bus (for example, main bus 70). The main power bus must be operable to monitor and control incoming power and outgoing power draw to the subsystems of the plant complex superstructure. The main power bus can be configured as required in view of the other selected subsystems 110, 112.

Constraints that apply to the main power bus comprise the total available power (which may be dependent upon the component 114 selection for the main power bus) and the maximum power draw which will set an upper constraint on the power which can be drawn at any one time for a particular configuration or element of the main power bus.

In embodiments, the selections for the main bus 70 may be done automatically based on renewable power subsystem 110R selections made. However, in some embodiments, manual selection may be available.

Plant Subsystems 112

Each plant subsystem 112 comprises one or more components 114. The components 114 correspond to functional elements of the subsystem and are each selectable from a pool of components 114. Components 114 may be modular and part of the design and configuration process may involve determining the number and size of any one type of component 114.

Consider, for example, an ammonia production plant having a hydrogen production plant subsystem 112. This subsystem 112, in embodiments, comprises one or more electrolysers. Electrolysers may be available from different manufacturers, may have different configurations and capacities, and be of different types. For example, the electrolysers may be selected from one or more of: alkaline electrolysers; PEM electrolysers; and solid oxide electrolysers.

The electrolysers may be modular and a plurality of electrolyser modules may be used together. For example, a single module may comprise a number of cells and have a total capacity of 20 MW, and the subsystem module 102 may enable any number of 20 MW electrolysers to be selected as part of the hydrogen production plant subsystem 112.

In addition, the hydrogen production plant subsystem 112 may comprise one or more purification and compression stages. The purification stages may be selected (or de-selected) from an available pool of components. Likewise, compression stages may be selected based on type, compression ratios, downstream pressures etc. from a pool of possible compressor configurations and components.

In addition, the subsystem module 102 may enable selection of bespoke components. For example, an electrolyser module having particular desired properties may be specified as an optimal solution which can then be manufactured to order.

The subsystem module 102 is further operable to define constraints on the construction and operation of the components within each plant subsystem 112 and between each component 114. This will be described in detail below in respect of the exemplary ammonia production plant.

However, considering again the plant subsystem 112 of the hydrogen production plant as an example, constraints may include technical constraints in normal operation such as power consumption, maximum and minimum capacities, efficiency (how much input energy is required to produce a NM 3 of hydrogen, for example), and variation of efficiency with load.

The constraints may also take into account dynamic processes—for example, ramp rates for start-up and shutdown of an electrolyser module. These constraints may also be linked to wider constraints and issues—for example, safety considerations in terms of maximum capacity and limitations on ramp rates to preserve component integrity and safety.

In addition, constraints may also be applied on longer timeframes; for example, to factor in performance and efficiency degradation over time, or to specify time intervals for repair and replacement of electrolyser modules and cells.

Constraints may also be applied in relation to the inter-dependency of parameters between plant subsystems 112 of the industrial gas plant complex superstructure 108 to be configured and designed. For example, further constraints may be applied to ramp rates of an upstream process which are beyond those of the technical limitations of the process in order to ensure that a downstream process is not subject to changes in gas flow beyond a design rate of change of the downstream process.

### Subsystem Module—Example of Ammonia Production Plant

The following non-limiting example relates to the design and configuration of an ammonia production plant complex superstructure.

The subsystems required for an ammonia production plant complex comprise, as set out in relation to FIG. 1, a hydrogen production plant 20, a hydrogen storage unit 30, hydrogen liquefier 32, air separation unit (ASU) 40, ASU storage unit 42, an ammonia synthesis plant 50, an ammonia storage unit 60 and an energy storage resource 76.

The subsystems and their interconnections (e.g. power connections, upstream/downstream process connections etc.) are specified in the subsystem module 102.

### Plant Subsystem 112—Hydrogen Production Plant Subsystem Example

For the hydrogen production plant subsystem 112, the non-limiting class of components to be specified are from the groups of: electrolysers, purification stages, and compression stages.

For the electrolyser, the subsystem module 102 enables selection of:

Electrolyser type (e.g. alkaline electrolysers; PEM electrolysers; solid oxide electrolysers);

Electrolyser technical properties (capacity per module (MVV), number of cells per module, number of modules, manufacturer or design of modules).

Design constraints and parameters for the electrolyser comprise:

Electrolyser operational characteristics (power consumption, maximum and minimum capacities, efficiency, variation of efficiency as a function of load).

Electrolyser specific parameters (demin Water Flow, average cell temperature, average cell pressure, cell voltage, cell current)

Electrolyser operability constraints (rate of change of performance and efficiency over time (i.e. ageing and degradation), mean or averaged time intervals between cell replacements or repair, mean or average time fore repair or replacement of electrolyser modules and cells).

Electrolyser safety constraints (maximum voltages, currents, maximum capacity, maximum load, limitations on ramp rates)

Electrolyser inter-dependency considerations (power draw as a proportion of available power, ramp rates to ensure appropriate rate of flow to downstream processes).

Other components that may be selected include purification systems which may be selected from:

Temperature swing absorption (TSA) components; deOxo systems (operational capacity, power draw, flow pressures)

Compressors (type, number of trains, number of stages, compression ratios, efficiency, power consumption, capacity, ramp rates for partial/full shutdown or start-up of compressors).

Compressor operational variables and constraints (compressor pressure and flow).

### Plant Subsystem 112—Hydrogen Storage Subsystem Example

A further subsystem may comprise a hydrogen storage resource 30. The components and constraints may comprise:

Storage type (spheres, bullets, caverns, size of each, number of each).

Storage infrastructure (physical size and space availability, capital expenditure, pipework).

Storage parameters and constraints (maximum and minimum storage pressure, maximum and minimum storage capacity, constraints on desired fill level).

Storage operational data (storage pressure, temperature, volume, leak management, time interval between repair or replacement, flow rates to/from gas storage).

### Plant Subsystem 112—Hydrogen Liquifier Subsystem Example

Additionally or alternatively to the use of hydrogen for ammonia synthesis in the ammonia synthesis plant 50, generated hydrogen may be liquified for onward distribution into the supply network S1.

Components of the hydrogen liquefier may comprise compression, cooling, expansion and storage components. Technical constraints and operational parameters for these components may comprise ramp rates and turndown rates, and storage volume.

Given the hydrogen liquefier may be designed to supply liquid hydrogen to the onward supply chain S1, further constraints may apply in the sense of market demand and carbon intensities for the production and onward transportation process.

For example, the hydrogen liquefier, if used as part of an ammonia plant, is required to produce enough liquid hydrogen to satisfy demand from the supply network S1 whilst maintaining sufficient hydrogen for ammonia production. These aspects place constraints on operating rates and ramp rates for the liquefaction system.

### Plant Subsystem 112—Air Separation Unit Subsystem Example

A further subsystem may comprise the ASU 40. The components and constraints may comprise:

Air separation unit type (process, manufacturer, capacity).

Air separation unit technical properties (efficiency, efficiency vs load, specific power, nitrogen recovery).

Air separation unit operability constraints and parameters (maximum and minimum capacity, efficiency, temperature differences in heat exchanger).

Air separation unit operability constraints (rate of change of performance and efficiency over time (i.e. ageing and degradation), mean or averaged time intervals between replacement or repair, mean or average time for repair or replacement of ASU components).

Air separation unit safety constraints (maximum capacity, maximum load, limitations on ramp rates).

Air separation unit inter-dependency considerations (power draw as a proportion of available power, ramp rates to ensure appropriate rate of flow to downstream processes).

### Plant Subsystem 112—Air Separation Unit Storage Subsystem Example

A further subsystem may comprise a nitrogen storage resource 42. The components and constraints may comprise:

Storage type (spheres, bullets, caverns, size of each, number of each).

Storage infrastructure (physical size and space availability, capital expenditure, pipework).

Storage parameters and constraints (maximum and minimum storage pressure, maximum and minimum storage capacity, constraints on desired fill level).

Storage operational data (storage pressure, temperature, volume, leak management, time interval between repair or replacement, flow rates to/from gas storage).

### PLANT SUBSYSTEM 112—AMMONIA PRODUCTION PLANT SUBSYSTEM Example

Ammonia production plant type (process, manufacturer, capacity).

Ammonia production plant type technical properties (efficiency, efficiency vs load, capacity).

Ammonia production plant operability constraints and parameters (maximum and minimum capacity, ramp rates and turndown limits, response to changing input gas flow (hydrogen and nitrogen)).

Ammonia production plant operational parameters (e.g. power consumed by ammonia loop, ammonia loop pressure and temperature, feed flow rates of nitrogen and hydrogen streams, ammonia plant syngas compressor pressure).

Ammonia production plant operability constraints (rate of change of performance and conversion loop efficiency over time (i.e. ageing and degradation), degradation of the catalyst bed, mean or averaged time intervals between replacement or repair, mean or average time for repair or replacement of ammonia production plant components).

Ammonia production plant safety constraints (maximum capacity, maximum load, limitations on ramp rates).

Ammonia production plant inter-dependency considerations (power draw as a proportion of available power, ramp rates to ensure appropriate flow from upstream processes).

### Plant Subsystem 112—Ammonia Production Plant Storage Subsystem Example

A further subsystem may comprise an ammonia storage resource 60. The components and constraints may comprise:

Storage type (spheres, bullets, caverns, size of each, number of each).

Storage infrastructure (physical size and space availability, capital expenditure, pipework).

Storage parameters and constraints (maximum and minimum storage pressure, maximum and minimum storage capacity, constraints on desired fill level).

Storage operational data (storage pressure, temperature, volume, leak management, time interval between repair or replacement, flow rates to/from gas storage).

In addition, given that stored ammonia is then supplied to the onward supply chain S2, further constraints may apply in the sense of market demand and carbon intensities for the production and onward transportation process of the ammonia.

For example, the ammonia plant 50 is required to produce enough ammonia to satisfy demand from the supply network S2 without requiring storage beyond practical design considerations. In addition, a further constraint in certain embodiments may be to produce sufficient ammonia to satisfy supply network S2 which also enabling production of sufficient liquid hydrogen for the supply chain S1. These aspects place constraints on operating rates and ramp rates for the ammonia production plant 50 and storage 60.

Simulation Module 104

The simulation module 104 is operable to receive data from the power subsystems 110 and from the subsystem module 102 and, for a plurality of different configurations of the industrial gas plant complex superstructure 108 selected from the configuration space, simulate operation of the plant complex in that configuration for a predetermined time period. The predetermined time period may comprise one or more years of operation.

The simulation module 104 is operable to utilize the data received, determined and/or generated by the subsystem module 106 to build a model of the industrial gas plant complex superstructure 108 in a selected configuration. The model includes the plant subsystems 112 and components 114 of those subsystems as defined in the subsystem module 102, in addition to all relevant constraints 116 defined in relation to those components 114 in the subsystem module 102.

The power prediction data is then utilized from the renewable power subsystems 110R and the simulation of a selected configuration is run to simulate the specific configuration in operation subject to the power data as predicted.

Simulation Model 104—Subsystem Models

The simulation model 104 utilizes physics-based models of the various subsystems to simulate plant behaviour for a predefined configuration. The physics-based models are primarily concerned with capturing energy consumption of subsystems at different operation rates. The following examples of physics-based models are now given.

For the simulation of the hydrogen production plant 20, associated physics-based models are, in embodiments, based on polarization curves of electrolyzers and may represent power consumption at different hydrogen production rates. The polarization curves change with time and resultant power consumption changes in response thereto. Such time-based degradation may, in embodiments, be included in the physics-based model of the hydrogen production plant 20.

To simulate the gas storage elements (for example, for hydrogen, nitrogen and/or ammonia) in the industrial gas production complex superstructure, the storage may represented by minimum and maximum allowable storage mass and flow rates at which gas can be stored or withdrawn.

One or more component of the hydrogen production plant 20 comprise compressors. In addition, hydrogen liquefaction requires compression. In order to model one or more compressors, power curves of compressor and operational philosophy of taking compressors into different modes at different flow rates is utilized. Overall, the compressor models represent power consumption at different rates with same pressure rise.

For the models of the ammonia production plant 50, these models represent power consumption of ammonia syngas compressor and refrigeration compressor at different ammonia production rates. A separate model may also be used to represent power generated by a steam turbine run using steam from ammonia. Taken together these models may represent net power consumed by ammonia production system at different ammonia production rates.

The Air Separation Unit 40 may be modelled by a simulation model which represents power consumption of the ASU 40 compressors at different rates. This may also based on compressor curves.

Miscellaneous components may be modelled as elements which consume a constant power draw per unit time.

Through the above, the simulation module 104 can capture power consumption realistically through the use of non-linear equations, modelling and empirical analysis.

Simulation Module Output Parameter

An output parameter can then be generated to act as an indicator metric. For example, in the context of an ammonia production plant being designed and configured, the output parameter may be the amount of ammonia produced in a predetermined time period. This time period may be, for example, a year.

In embodiments, the simulation may determine an optimized or maximized value of the output parameter in the predetermined time period. This may be done by altering the process variables for the simulated plant within the boundaries of the defined constraints and in response to the predicted available power data to achieve a maximum or optimized value for the output parameter.

In embodiments, the output parameter may be the amount of ammonia produced in the predetermined time period, e.g. 1 year. Thus, the output parameter from the model is an estimation of the maximum amount of ammonia that can be generated for any one specific configuration based on the most appropriate selection from the available range of renewable power resources.

The optimization may utilize simulated set points of the control processes in the plant complex 110 at specific time periods to balance the predicted available power against the consumed power so that right amount of hydrogen is produced and ammonia plant runs at the correct rate to maximize ammonia production.

In other words, the simulation module 104 solves an optimization algorithm applied to a dynamic mathematical model of the configuration of the industrial gas plant complex superstructure 108 under consideration. The predicted available renewable power WPi and SPi and constraints of the various components and subsystems of the simulated configuration of the industrial gas plant complex superstructure 108 are taken as the inputs and applied to the optimization algorithm to propose optimal rates at which to run the ammonia plant for a specific predetermined time period.

Alternatively, an output parameter may be a plant complex superstructure configuration in which, given a range of available renewable resource power profiles, reliance on external power sources such as the local grid 80 is minimized.

The simulation module 104 may also utilise data relating to the energy storage device(s) 76 (if implemented in a specific configuration). The status, operational characteristics, availability, resource storage level and ease of power availability of each of the units of the storage resource 76 may be factored into the optimization problem.

In embodiments, the simulation of the plant complex 110, including the selected plant subsystems 112 and all components 114 thereof, together with applicable constraints 116, may be defined as a mixed integer linear programming (MILP) problem. However, other optimization solver techniques are available.

Predicted power data may be on an hour by hour timescale and the model may simulate the full operation of the specified configuration of the plant 110 including equipment failures and repairs over a timescale of at least one year, preferably over multiple years.

Simulation Model—Selection of Configurations

In the example of an ammonia production plant, the configuration space for plant subsystem 112 selection and component 114 selection is extremely large and multi-dimensional. Therefore, whilst specific configurations could be selected manually, this may in certain configuration spaces represent an intractable problem. Thus, it is necessary to automate selection of different configurations to enable the configuration space to be explored.

In embodiments, a selection method is used to select a multiplicity of configurations for simulation. In embodiments, a selection protocol is implemented to select automatically particular configurations for simulation from the available configuration space.

In non-limiting embodiments, a sampling method may be used. In non-limiting embodiments, the Latin hypercube sampling technique may be used. Latin hypercube sampling is a statistical approach operable to generate a near-random sample of values from a multidimensional distribution space. However, other methods may be used; for example, random sampling or orthogonal sampling.

In the present invention, the distribution space represents the possible configurations of the plant complex superstructure 108 from which near-random samples are selected. Once a multiplicity of configurations are selected, each configuration can be run in the simulation to determine the maximum or optimized value of the output parameter for that particular configuration. When these values are obtained, variables in configuration space can be obtained where the value of the output parameter as a function of configuration can be obtained.

Optimization Module 106

Once the configurations have been generated and simulated by the simulation module 104, the optimization module 106 has access to a configuration data space in which various configurations have been simulated defining a plurality of configuration data points within the configuration space. This will give a simulated value of the output parameter for that configuration.

In embodiments, the output parameter may be the maximum ammonia production in a predetermined timeframe (e.g. 1 year) determined for each configuration. Alternatively, the output parameter may be the proportional or absolute usage of external power resources such as the local power grid 80 in the predetermined timeframe (e.g. 1 year).

However, given the large number of possible configurations, the multiplicity of configurations, as described above, are selected in accordance with random or pseudo-random techniques in the configuration space. Thus, further optimization is necessary to select the optimum configuration for production.

In embodiments, this is handled by the optimization module 106. The optimization model 108 seeks to identify, within the configuration space, one or more maximized or optimized configurations which meets technical, safety, efficiency and commercial requirements whilst optimizing, maximizing or minimizing the desired output parameter. In embodiments, the output parameter may be the maximum amount of ammonia for a selected power profile from the available power profiles.

The optimization module 106 enables relationships between configuration options to be identified, and the dependency of the ammonia production value on the selection or deselection particular components or subsystems to be identified.

In embodiments, the optimization module 106 utilizes a surrogate optimization model in the configuration space to identify a configuration which yields the maximum ammonia production whilst meeting technical, safety, efficiency and commercial requirements (for example, to identify the most efficient, reliable and safe system with the lowest capital expenditure leading to the lowest LCOA (levelized cost of ammonia)).

In embodiments, the surrogate model uses any suitable model or statistical process operable to estimate the relationship between the dependent variable of maximised ammonia production and the plurality of independent variables of the subsystem and component selections for each configuration.

In embodiments, a regression model is used as the surrogate model. Alternatively or additionally, the surrogate model may be based on a machine learning framework. Any suitable machine learning algorithm may be used.

For example, the model may utilise techniques such as Gradient boosting (utilising, for example, XGboost), Long short-term memory (LSTM), support vector machine (SVM) or random decision forests may be used in such a model.

Gradient boosting is a machine learning technique utilized in regression and classification problems. A strong prediction model is formed which comprises an ensemble of weak prediction models such as decision trees. A stage-wise process may be used to generate the model through steepest descent minimisation (amongst others).

LSTM is an artificial recurrent neural network architecture which has feedback connections as well as feedforward connections. A common LSTM unit is composed of a cell, an input gate, an output gate and a forget gate. The cell is operable to remember values over an arbitrary time interval the flow of information into and out of the cell is regulated by the gates.

A support vector machine utilises a set of training examples, each comprised in one of two categories, and generates a model that assigns new examples to a particular category. Thus, a SVM comprises a non-probabilistic binary linear classifier.

Random decision forests comprise ensemble machine learning methods which operate by constructing a multitude of decision trees during a training process and outputting the class that is the mode of the classes (classification) or mean/average prediction (regression) of the individual trees.

The output of the optimization module 106 may be, in embodiments, a configuration of industrial gas production plant complex superstructure 108 which meets all necessary efficiency, safety, regulatory, spatial, engineering and commercial constraints whilst producing an optimal or maximal amount of ammonia for the lowest cost based on the available renewable power resources.

Such optimization is not possible using conventional methods. For example, the inventors have found that a plant complex superstructure can be designed using the approach of the present invention which has much higher utilization of the available power from renewable sources when compared to a plant complex designed using other methods.

Method of Operation

In embodiments, there is provided a method and system for selecting a design configuration of an industrial gas plant complex comprising one or more industrial gas plants and powered by one or more renewable power sources. The method is executed by at least one hardware processor.

Step 200—Define Model of Superstructure Subsystems

At step 200, a computational model defining a model of the modelled industrial gas is provided. The computational model of the industrial gas production complex superstructure comprises selectable elements so that a plurality of selectable configurations representative of potential configurations of the industrial gas production complex superstructure can be defined therein.

The computational model comprises a plurality of selectable modelled renewable power subsystems 110R and selectable modelled plant subsystems 112. Optionally or additionally, support power subsystems 110S may also be defined in the model.

The subsystems 110R, 110S, 112 may be selected from a group or pool of available subsystems. Some subsystems may be user-specified and part of the basic design requirements of the industrial gas production complex superstructure (e.g. the type of industrial gas production complex superstructure that is required in terms of gas production or renewable power generation level).

Other subsystems may be optional or selectable from a group of available subsystems during the configuration process. By “available” is meant that a particular subsystem is compatible with or can be used as part of an overall design requirement and is included in the model.

By “selectable” is meant that the model may be provided with a number of different subsystems that may be selected to define a particular configuration of the modelled industrial gas plant complex superstructure 108 within the model. These selections may be made available or provided manually or may be system-defined based on available data or predicted date.

In step 200, the subsystem module 102 receives data specifying the type and configuration of the subsystems of the industrial gas plant complex superstructure 108 to be designed and configured. This data depends on the nature of the industrial gas plant complex superstructure such as its intended use and configuration (for example, an ammonia or hydrogen production plant).

In embodiments, the subsystem module 102 may be utilized to specify or determine the subsystems forming part of the industrial gas plant complex superstructure 108 to be analysed and optimized. The subsystem module 102 may be utilized in this step to specify the initial model of the industrial gas plant complex superstructure 108 to be configured and designed and enables specification of both one or more renewable power subsystems 110R and one or more plant subsystems 112 therein in accordance with subsequent steps.

In embodiments, the industrial gas plant complex superstructure 108 comprises an ammonia production plant. The subsystems required for an ammonia production plant complex may comprise a hydrogen production plant 20, a hydrogen storage unit 30, an Air Separation Unit (ASU) 40, ASU storage unit 42, an ammonia synthesis plant 50, an ammonia storage unit 60, a main bus 70, wind and solar renewable power sources 72, 74 and an energy storage resource 76. Optionally, a hydrogen liquefier 32 may also be provided.

The subsystems and their interconnections (e.g. power connections, upstream/downstream process connections etc.) are specified in the subsystem module 102 as discussed below.

The model provides a configuration space in which different configurations of modelled industrial gas plant complex superstructure 108 can be defined. The selectable components is derived from the definitions in steps 210 and 220.

Step 210—Specify Superstructure Renewable Power Subsystems

In this step, a plurality of selectable modelled renewable power subsystems are specified in the model. Each modelled renewable power subsystem has predicted time series power profile data for a predetermined time period associated therewith.

In this step, one or more renewable power subsystems 110R may be selected by a user or automatically. The renewable power subsystems 110R are available to be selected automatically or manually during configuration of the model of the subsystem module 102. For renewable power subsystems 110R, specific components may not be material to the present invention and, in embodiments, the renewable power subsystems 110R may be defined only by parameters and any relevant constraints.

By this is meant that the detailed specification of renewable power subsystem 110R components (for example, the type, number and configuration of wind turbines or solar panels) of one or more renewable power subsystems 110R is not material to the present invention. However, in embodiments, the parameters of each power subsystem 110 can be specified based on particular design and/or configuration requirements.

Each renewable power subsystem 110R is grouped by type, e.g. wind, solar, tidal etc. Within each group, a range of renewable power subsystems 110R can be selected having different operational parameters associated therewith as described in step 220.

Each modelled renewable power subsystem has predicted time series power profile data for a predetermined time period associated therewith. Predicted power profiles comprise, in embodiments, the estimated power produced by a given configuration of renewable power subsystem 110R for a given number of intervals (e.g. 1 hour) over a predetermined period of time (e.g. 1 year). This shows the predicted daily power availability of the given renewable power subsystem 110R.

The power profile module 110A is operable to receive time-dependent power profile data for the one or more renewable power sources. In non-limiting embodiments, time-dependent operational and meteorological data for the location or site for the one or more renewable power source(s) for a predetermined period of time is received.

In embodiments, the time period is at least a year. In embodiments this may be multiple years. The time-series data represents the available power from renewable sources as a function of time.

In embodiments, if the renewable power subsystem(s) 110 under consideration are comparable to an existing renewable power source such as a wind farm or solar farm (or selected part thereof), then the variables of wind power WPi and solar power SPi in time-series data for a predetermined time period may be available to use as predicted data for future estimation and design. In embodiments, the index i represents time from period n to n+k and this data may be available at intervals of fixed duration with the power generated expressed in units of MW as a function of time.

However, if no existing time-series power data is available (for example, if the renewable power site has yet to be built) then the time-series power data can be estimated. In embodiments, the time-series power data can be estimated from weather sources and from technical information.

In this step, technical data may also be used. For wind farms, this may comprise known wind farm layouts and design, selection and number of turbines. For solar farms, technical details such as the type, area, efficiency and number of panels and their location and orientation may be modelled with suitable software. This data may then be used to generate predicted power profiles over a predetermined period of time. The period of time may be based on historical data (e.g. past wind data for a period of one or more years) or may be based on predicted future data derived from a machine learning process, for example.

The predicted average power data may be used to generate P50 and P90 power profiles for the predetermined time period. P50 represents a median value of the annual estimate of power production from the renewable resource such that over the life of the project the power production at any given time has a 50% probability of falling below the P50 value and a 50% probability of exceeding the P50 value.

The P90 value is more conservative and represents an average power value that will be met or exceeded 90% of the time.

However, whilst P50 and P90 are widely used in the respective industries, any suitable metric may be used. For example, P25, P75, or any other suitable metric.

It is further noted that the data utilized by the power subsystems 110 may be obtained by any suitable means and the above discussion does not limit the power subsystems 110 to any requirement for data generation. Indeed, the data may be provided from an external source.

The average wind power WPi and average solar power SPi may be provided or generated for a time period which, in embodiments, is a year or more. The data may comprise a time series where index i represents time from period n to n+k in intervals of fixed duration. In non-limiting embodiments, the intervals may comprise 15 minutes, 30 minutes or 1 hour.

The predicted time series data may be modified for each selectable modelled renewable power subsystem depending upon operational parameters and constraints described in step 220 (which may form part of step 210 in embodiments). In embodiments, the magnitude of the predicted time series data may be scaled depending upon operational parameters and constraints such as wind/solar farm size as described below.

Step 220—Associate Operational Parameters and Constraints with Renewable Power Subsystems

Step 220 may take place simultaneously with and/or integrated into step 210 or may be carried out as a separate stage. The configuration space of renewable power subsystems is defined in step 210. A plurality of operational parameters and a plurality of operational constraints can then be associated with each of the plurality of modelled renewable power subsystems in step 220.

The operational parameters may comprise the maximum and minimum power profile of the given renewable power subsystem 110R. How power profiles are derived is explained in the section below in relation to power prediction module 110A.

Each available renewable power subsystem 110R is arranged to be selectable in later steps as an entity with particular operational parameters. In embodiments, no internal components are selectable. However, parameters such as the maximum power generation of a renewable power subsystem 110R may be specified. This allows a selection of a renewable power subsystem 110R having available power generation which is scaled to meet the demands of the industrial gas plant complex superstructure.

In other words, the predicted time series power profile data for a subsystem 110R-1 having operational parameters and constraints defining a useable farm area half that of another subsystem 110R-2 will have equivalent predicted time series power profile data that has a magnitude half that of the data for subsystem 110R-2.

This selectability may derive from real-world design decisions. For example, it may be that a particular area of land is available for provision of renewable resources (wind and/or solar). If the entirety of the land area is utilized for wind power then that energy resource may generate a particular power profile (the maximum or expected power delivered over a predefined period of time such as a year). This defines an upper bound or constraint on the maximum wind power which could be generated with the available resource. The same applies if the whole of the resource is used for solar power.

However, if only a part of the available resource area is used for wind, for example a minimum commercially or technically viable size of wind farm resource, then this would define a lower bound on the power profile for the wind power resource. However, the power profile would essentially be the same in profile for each size, albeit scaled so that the magnitude is proportional to the selected size of wind farm.

Again, this applies to solar power. Therefore, in this example, it can be seen that a range of parameters for each renewable power subsystem 110R can be defined and used as part of the global superstructure optimization problem to select the appropriate power profile for the desired superstructure configuration.

The defined range (either discrete or continuous) of configurations of available renewable power subsystems 110R which provide specific maximum power generation amounts for given power profiles enables a mix of renewable sources to be investigated and an optimal configuration selected.

For example, the optimization process can utilize data relating to a tailored selection of wind and solar resources. Solar power may provide more consistent power during daylight hours, but wind power may provide more flexibility and power generation during hours of darkness. Thus, a specific mix of these power profiles can be used as part of the configuration selection to identify a maximised power profile for use with a particular configuration of plant subsystems 112.

The maximum and minimum power generation may be constraints and parameters which can be selected. However, other constraints may be assigned as appropriate.

For example, constraints 116 may apply safety considerations in terms of maximum capacity and limitations on power generation, or rate of change of generation to preserve component integrity and safety.

In addition, constraints 116 may also be applied to the renewable power subsystems 110R on longer timeframes; for example, to factor in performance and efficiency degradation over time, or to specify time intervals for repair and replacement of renewable power subsystems.

Constraints 116 may also be applied in relation to the inter-dependency of parameters between renewable power subsystems 110R and plant subsystems 112 of the industrial gas plant complex superstructure 108 to be configured and designed. For example, further constraints may be applied to ensure ramp rates for renewable power subsystems 110R do not exceed those of the technical limitations of the powered plant subsystems 112.

Step 230—Specify Superstructure Support Power Subsystems, Associate Operational Parameters and Constraints

This step is optional and enables support power subsystems 110S to be specified if required.

In some cases, components 114 of one or more support power subsystems 110S may be specified. The components 114 correspond to functional elements of the subsystem and are each selectable from a pool of components. Components 114 may be modular and part of the design and configuration process may involve determining the number and size of any one type of component 114.

The subsystem module 102 is further operable to define constraints 116 on the construction and operation of the components 114 within each power subsystem 110 and between each component 114.

Constraints may include technical constraints in normal operation such as power consumption, maximum and minimum capacities, efficiency, and variation of efficiency with load.

The constraints 116 may also take into account dynamic processes—for example, ramp rates for start-up and shutdown of an energy storage resource. These constraints 116 may also be linked to wider constraints and issues—for example, safety considerations in terms of maximum capacity and limitations on ramp rates to preserve component integrity and safety.

In addition, constraints may also be applied on longer timeframes; for example, to factor in performance and efficiency degradation over time, or to specify time intervals for repair and replacement of battery modules.

Constraints 116 may also be applied in relation to the inter-dependency of parameters between power subsystems 110 and plant subsystems 112 of the industrial gas plant complex superstructure 108 to be configured and designed. For example, further constraints may be applied to ensure ramp rates for power subsystems 110 do not exceed those of the technical limitations of the powered plant subsystems 112.

However, for other power subsystems 110 such as renewable power subsystems 110R, components may not be material to the present invention and these power subsystems 110R may be defined only by parameters and any relevant constraints.

By this is meant that the detailed selection of renewable power subsystem 110R components (for example, the type, number and configuration of wind turbines or solar panels) of one or more renewable power subsystems 110R is not material to the present invention. However, in this case, the parameters of each renewable power subsystem 110R can be specified based on particular configuration requirements. Thus the configuration space for renewable power subsystem(s) 110R relates to a scaling of the subsystems from a maximum to a minimum value.

Step 240—Specify Superstructure Plant Subsystems

In this step, a plurality of selectable modelled plant subsystems 112 are specified in the model. Each modelled selectable modelled plant subsystems 112 has a plurality of selectable modelled components associated therewith.

In this step, one or more modelled plant subsystems 112 may be selected by a user or automatically. The modelled plant subsystems 112 are available to be selected automatically or manually during configuration of the model of the subsystem module 102.

Each modelled plant subsystems 112 is grouped by type, e.g. gas production plant subsystems or gas storage subsystems. Within each group the subsystems may comprise one or more of: hydrogen production plant; air separation unit; and ammonia production plant, and wherein the gas storage subsystems comprise one or more of: hydrogen gas storage; hydrogen liquefier; nitrogen storage; and ammonia storage.

Within each group, a range of modelled plant subsystems 112 can be selected having different operational parameters associated therewith as described in step 220.

Step 250—Associate Plant Operational Parameters, Components and Constraints

Step 250 may take place simultaneously with and/or integrated into step 240 or may be carried out as a separate stage. The configuration space of plant subsystems is defined in step 240. A plurality of operational parameters and a plurality of operational constraints can then be associated with each of the plurality of modelled plant subsystems in step 250.

In this step, parameters and/or components 114 of each plant subsystem 112 are specified. Constraints 116 are then applied to the plant subsystems 112 and components 114 within the industrial plant complex superstructure 108.

In more detail, the subsystem module 102 receives data specifying the type and subsystems of the industrial gas plant complex superstructure to be designed and configured. This data depends on the nature of the industrial gas plant complex superstructure 108.

Each plant subsystem 112 comprises one or more components 114. The components 114 correspond to functional elements of the plant subsystem 112. The components 114 are selectable from a defined pool of components. Components may be modular and part of the design and configuration process may involve determining the number and size of any one type of component.

In addition, the subsystem module 102 may enable selection of bespoke components. For example, an electrolyser module having particular desired properties may be specified as an optimal solution which can then be manufactured to order.

The subsystem module 102 is can specify and define constraints on the construction and operation of the components within each plant subsystem 112 and between each component 114. Constraints may include technical constraints in normal operation such as power consumption, maximum and minimum capacities, efficiency, and variation of efficiency with load.

Constraints may relate to dynamic processes—for example, ramp rates for start-up and shutdown of a component. These constraints may also be linked to wider constraints and issues—for example, safety considerations in terms of maximum capacity and limitations on ramp rates to preserve component integrity and safety.

In addition, constraints may also be applied on longer timeframes; for example, to factor in performance and efficiency degradation over time, or to specify time intervals for repair and replacement of electrolyser modules and cells.

Constraints may also be applied in relation to the inter-dependency of parameters between plant subsystems 112 of the industrial gas plant complex superstructure 108 to be configured and designed. For example, further constraints may be applied to ramp rates of an upstream process which are beyond those of the technical limitations of the process in order to ensure that a downstream process is not subject to changes in gas flow beyond a design rate of change of the downstream process.

The subsystems defined in step 200, and the pool of possible components and associated technical parameters and constraints define the configuration space from which configurations can be selected in later steps.

Step 260—Select Configurations

At step 260, a plurality of configurations is selected from the configuration space defined in steps 200 to 250. This may be done by any suitable method. At step 260 a plurality of configurations is selected of the model by selecting, for each configuration: one or more modelled renewable power subsystems; one or more modelled plant subsystems; and one or more components associated with the selected one or more modelled plant subsystems as defined in steps 200 to 250.

In embodiments, the selection step selects a multiplicity of configurations for simulation. In embodiments, the selection step comprises a sampling method. In non-limiting embodiments, the Latin hypercube sampling technique may be used. However, other methods may be used; for example, random sampling or orthogonal sampling.

In the present invention, the distribution space represents the possible configurations of the plant complex superstructure 108 from which near-random samples are selected. Once a multiplicity of configurations are selected, each configuration can be run in the simulation in step 270 to determine the maximum or optimized value of the output parameter for that particular configuration. When these values are obtained, variables in configuration space can be obtained where the value of the output parameter as a function of configuration can be obtained.

In embodiments, a multiplicity of configurations is selected in step 260. In examples, the number of configurations selected may be greater than 1000.

Step 270—Simulate Configurations

In step 270, once the plurality of configurations is selected, the configurations can be run in a simulation. In this step, the simulation module 104 is operable to utilize the data received, determined and/or generated by the subsystem module 106 in steps 200 to 250 and the configuration(s) selected in step 260 to build a model of the industrial gas plant complex superstructure 108 in the selected configurations.

The model includes the renewable power subsystems 110R, plant subsystems 112 and components 114 of those subsystems as defined in the subsystem module 102, in addition to all relevant constraints 116 defined in relation to those subsystems 110R, 112 and components 114 in the subsystem module 102. The above may also include support power subsystems 110S if included.

For each simulated configuration, a configuration of the configuration of the renewable power subsystems 110R is selected. A power profile is associated with this configuration of renewable power subsystem 110R and this can then be used in the simulation of the selected configuration to simulate the specific plant configuration in operation subject to the power data as predicted from the selected renewable power subsystem(s) 110R configuration. The simulation is then run to obtain predetermined metrics.

Step 280—Generate Output Parameter

Steps 270 and 280 may be integrated together in embodiments. At step 280, the operation of the simulation in step 270 is operable to determine a maximum or optimized value of an output parameter for each configuration. When these values are obtained, variables in the configuration space can be obtained where the value of the output parameter as a function of configuration can be obtained.

In other words, steps 270 and 280 enable determination of, for each selected configuration, the predicted operation of the configuration selected in step 260 of an industrial gas production complex superstructure over a predetermined time period to determine a maximum value of a predetermined operational output parameter for the selected configuration and for the predetermined time period. The predicted operation utilizes the power profile data associated with the one or more selected renewable power subsystems and the operational parameters and operational constraints associated with the selected configuration.

In other words, an output parameter is generated to act as an indicator metric. For example, in the context of an ammonia production plant being designed and configured, the output parameter may be the amount of ammonia produced in a predetermined time period. This time period may be, for example, a year.

In this step the simulation may determine an optimized or maximized value of the output parameter in the predetermined time period. This may be done by altering the process variables for the simulated plant within the boundaries of the defined constraints and in response to the predicted available power data to achieve a maximum or optimized value for the output parameter.

In embodiments, the output parameter may be the amount of ammonia produced in the predetermined time period, e.g. 1 year. Thus the output parameter from the model is an estimation of the maximum amount of ammonia that can be generated for any one specific configuration based on the available renewable power resources.

The optimization may utilize simulated set points of the control processes in the plant complex 110 at specific time periods to balance the predicted available power against the consumed power so that right amount of hydrogen is produced and ammonia plant runs at the correct rate to maximize ammonia production.

In other words, the simulation module 104 solves an optimization algorithm applied to a dynamic mathematical model of the configuration of the industrial gas plant complex superstructure 108 under consideration. The predicted available renewable power WPi and SPi and constraints of the various components and subsystems of the simulated configuration of the industrial gas plant complex superstructure 108 are taken as the inputs and applied to the optimization algorithm to propose optimal rates at which to run the ammonia plant for a specific predetermined time period.

Step 290—Build Surrogate Model

Once the multiplicity of configurations have been selected in step 260 and simulated by the simulation module 104 in steps 270 and 280, the optimization module 106 has access to a configuration data space in which a large number of configurations have been simulated and the output parameter (e.g. the maximum ammonia production in a predetermined timeframe (e.g. 1 year)) determined for each simulated configuration.

In embodiments, the surrogate model may comprise any suitable model or statistical process operable to estimate the relationship between the dependent variable of maximised ammonia production and the plurality of independent variables of the subsystem and component selections for each configuration.

In embodiments, a regression model is used as the surrogate model. Alternatively or additionally, the surrogate model may be based on a machine learning framework. Any suitable machine learning algorithm may be used.

For example, the model may utilise techniques such as Gradient boosting (utilising, for example, XGboost), Long short-term memory (LSTM), support vector machine (SVM) or random decision forests may be used in such a model.

Step 300—Optimize

In step 300, the surrogate model forming part of the optimization model 108 and built in step 290 is utilized to identify, within the configuration space, an optimum configuration which meets one or more predetermined parameter. In embodiments, the predetermined parameter comprises an optimized amount of ammonia for a given available power profile, whilst meeting technical, safety, efficiency and commercial requirements.

The optimization module 106 enables relationships between configuration options to be identified, and the dependency of the ammonia production value on the selection or deselection particular components or subsystems to be identified.

In embodiments, the optimization module 106 utilizes a surrogate model in the configuration space to identify a configuration which yields the maximum ammonia production and which meets technical, safety, efficiency and commercial requirements (for example, to identify the most efficient, reliable and safe system with the lowest capital expenditure leading to the lowest LCOA (levelized cost of ammonia).

The output of the optimization module 106 may be, in embodiments, a configuration of industrial gas production plant complex superstructure 108 which meets all necessary efficiency, safety, regulatory, spatial, engineering and commercial constraints whilst producing an optimal or maximal amount of ammonia for the lowest cost based on the available renewable power resources.

In other words, step 300 outputs one or more optimized designs of industrial gas production plant complex superstructure 108 for implementation and construction. Each design may comprise one or more selected renewable power subsystems 110R having particular parameters, and one or more selected plant subsystems 112 and components 114 thereof.

The design can then be utilized to inform the design of a real-world plant having improved efficiencies and which is well matched to one or more renewable power sources. The present invention enables, for the first time, both renewable power sources and industrial gas plant systems to be configured and optimized simultaneously, leading to significant technical benefits.

Step 310—Build Plant

At step 310, the generated design in step 300 can be constructed as appropriate.

While the invention has been described with reference to the preferred embodiments depicted in the figures, it will be appreciated that various modifications are possible within the spirit or scope of the invention as defined in the following claims.

In the specification and claims, the term “industrial gas plant” is intended to refer to process plants which produce, or are involved in the production of industrial gases, commercial gases, medical gases, inorganic gases, organic gases, fuel gases and green fuel gases either in gaseous, liquified or compressed form.

For example, the term “industrial gas plant” may include process plants for the manufacture of gases such as those described in NACE class 20.11 and which includes, non-exhaustively: elemental gases; liquid or compressed air; refrigerant gases; mixed industrial gases; inert gases such as carbon dioxide; and isolating gases. Further, the term “industrial gas plant” may also include process plants for the manufacture of industrial gases in NACE class 20.15 such as ammonia, process plants for the extraction and/or manufacture of methane, ethane, butane or propane (NACE classes 06.20 and 19.20), and manufacture of gaseous fuels as defined by NACE class 35.21. The above has been described with respect to the European NACE system but is intended to cover equivalent classes under the North American classifications SIC and NAICS. In addition, the above list is non-limiting and non-exhaustive.

In some of the examples a hydrogen storage system and in some cases a purification unit are shown. However, it will be appreciated that the present invention can be implemented without the use of a hydrogen storage system or purification unit, which are only shown here for completeness.

In this specification, unless expressly otherwise indicated, the word “or” is used in the sense of an operator that returns a true value when either or both of the stated conditions are met, as opposed to the operator “exclusive or” which requires only that one of the conditions is met. The word “comprising” is used in the sense of “including” rather than to mean “consisting of”.

In the discussion of embodiments of the present invention, the pressures given are absolute pressures unless otherwise stated.

All prior teachings above are hereby incorporated herein by reference. No acknowledgement of any prior published document herein should be taken to be an admission or representation that the teaching thereof was common general knowledge in Australia or elsewhere at the date thereof.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

While various operations have been described herein in terms of “modules”, “units” or “components,” it is noted that that terms are not limited to single units or functions. Moreover, functionality attributed to some of the modules or components described herein may be combined and attributed to fewer modules or components. Further still, while the present invention has been described with reference to specific examples, those examples are intended to be illustrative only, and are not intended to limit the invention. It will be apparent to those of ordinary skill in the art that changes, additions or deletions may be made to the disclosed embodiments without departing from the spirit and scope of the invention. For example, one or more portions of methods described above may be performed in a different order (or concurrently) and still achieve desirable results.

What is claimed is:

1. A method of configuring an industrial gas production complex superstructure comprising one or more plant subsystems and being powered at least in part by one or more renewable power subsystems, the method being executed by at least one hardware processor and comprising:
providing a model of the industrial gas production complex superstructure having a plurality of selectable configurations representative of potential configurations of the industrial gas production complex superstructure;
specifying, in the model, a plurality of selectable modelled renewable power subsystems, each modelled renewable power subsystem having predicted time series power profile data for a predetermined time period associated therewith;
specifying, in the model, a plurality of selectable modelled plant subsystems, each selectable modelled plant subsystem having a plurality of selectable modelled components associated therewith;
associating a plurality of operational parameters and a plurality of operational constraints with each of the plurality of modelled renewable power subsystems, with each of the plurality of modelled plant subsystems and with the each of the plurality of selectable modelled components;
selecting a plurality of configurations of the model by selecting, for each configuration: one or more modelled renewable power subsystems; one or more modelled plant subsystems; and one or more components associated with the selected one or more modelled plant subsystems;
determining, for each selected configuration, the predicted operation of the selected configuration of an industrial gas production complex superstructure over a predetermined time period to determine a maximum value of a predetermined operational output parameter for the selected configuration and for the predetermined time period, the predicted operation utilizing the power profile data associated with the one or more selected renewable power subsystems and the operational parameters and operational constraints associated with the selected configuration;
utilizing a surrogate model to identify, based on the operational output parameter data and the selected configuration data for each configuration, one or more configurations of the industrial gas production complex superstructure operable to maximize the value of the operational output parameter whilst meeting the predefined operational constraints; and
generating one or more designs for the industrial gas production complex superstructure based on the identified one or more configurations.

2. A method according to claim 1, wherein the plurality of selectable modelled renewable power subsystems is arranged in groups of: wind farm subsystems, solar farm subsystem, tidal power subsystems and hydroelectric power subsystems.

3. A method according to claim 2, wherein within each of said groups a plurality of selectable modelled renewable power subsystems are available to be selected, each selectable modelled renewable power subsystem sharing the same profile of the predicted time series power profile data but varying in the magnitude of the available maximum power.

4. A method according to claim 2, wherein a plurality of selectable modelled renewable power subsystems may be selected from at least two different groups.

5. A method according to claim 1, wherein the plurality of selectable modelled plant subsystems is arranged in groups of: gas production plant subsystems and gas storage subsystems.

6. A method according to claim 5, wherein the gas production plant subsystems comprise one or more of: hydrogen production plant; air separation unit; and ammonia production plant, and wherein the gas storage subsystems comprise one or more of: hydrogen gas storage; hydrogen liquefier; nitrogen storage; and ammonia storage.

7. A method according to claim 6, wherein at least one selected gas production plant subsystem comprises a hydrogen production plant and wherein the selectable modelled components for the hydrogen production plant are selectable from one or more of: electrolyser type; electrolyser capacity; compressor systems; purifier systems.

8. A method according to claim 1, wherein the predetermined operational output parameter comprises the amount of gas produced by the industrial gas production complex superstructure.

9. A method according to claim 1, further comprising:
constructing an industrial gas production complex superstructure according to the design.

10. A system for configuring an industrial gas production complex superstructure comprising one or more plant subsystems and being powered at least in part by one or more renewable power subsystems, the system comprising:
at least one hardware processor;
a subsystem module operable to:
provide a model of the industrial gas production complex superstructure having a plurality of selectable configurations representative of potential configurations of the industrial gas production complex superstructure;
specify a plurality of selectable modelled renewable power subsystems, each modelled renewable power subsystem having predicted time series power profile data for a predetermined time period associated therewith; and
specify a plurality of selectable modelled plant subsystems, each selectable modelled plant subsystem having a plurality of selectable modelled components associated therewith;
a simulation module operable to:
associate a plurality of operational parameters and a plurality of operational constraints with each of the plurality of modelled renewable power subsystems, with each of the plurality of modelled plant subsystems and with the each of the plurality of selectable modelled components;
select a plurality of configurations by selecting, for each configuration: one or more modelled renewable power subsystems; one or more modelled plant subsystems; and one or more components associated with the selected one or more modelled plant subsystems; and
determine, for each selected configuration, the predicted operation of the selected configuration of an industrial gas production complex superstructure over a predetermined time period to determine a maximum value of a predetermined operational output parameter for the selected configuration and for the predetermined time period, the predicted operation utilizing the power profile data associated with the one or more selected renewable power subsystems and the operational parameters and operational constraints associated with the selected configuration; and
an optimization module operable to:
utilize a surrogate model to identify, based on the operational output parameter data and the selected configuration data for each configuration, one or more configurations of the industrial gas production complex superstructure operable to maximize the value of the operational output parameter whilst meeting the predefined operational constraints; and
generate one or more designs for the industrial gas production complex superstructure based on the identified one or more configurations.

11. A system according to claim 10, wherein the plurality of selectable modelled renewable power subsystems is arranged in groups of: wind farm subsystems, solar farm subsystem, tidal power subsystems and hydroelectric power subsystems.

12. A system according to claim 11, wherein within each of said groups a plurality of selectable modelled renewable power subsystems are available to be selected, each selectable modelled renewable power subsystem sharing the same profile of the predicted time series power profile data but varying in the magnitude of the available maximum power.

13. A system according to claim 11, wherein a plurality of selectable modelled renewable power subsystems may be selected from at least two different groups.

14. A system according to claim 10, wherein the plurality of selectable modelled plant subsystems is arranged in groups of: gas production plant subsystems and gas storage subsystems.

15. A system according to claim 11, wherein the gas production plant subsystems comprise one or more of: hydrogen production plant; air separation unit; and ammonia production plant, and wherein the gas storage subsystems comprise one or more of: hydrogen gas storage; hydrogen liquefier; nitrogen storage; and ammonia storage.

16. A system according to claim 15, wherein at least one selected gas production plant subsystem comprises a hydrogen production plant and wherein the selectable modelled components for the hydrogen production plant are selectable from one or more of: electrolyser type; electrolyser capacity; compressor systems; purifier systems.

17. A system according to claim 10, wherein the predetermined operational output parameter comprises the amount of gas produced industrial gas production complex superstructure.

18. A computer readable storage medium storing a program of instructions executable by a machine to perform a method of controlling an industrial gas production facility comprising one or more industrial gas plants powered by a power network including one or more renewable power sources, the method being executed by at least one hardware processor, the method comprising:
providing a model of the industrial gas production complex superstructure having a plurality of selectable configurations representative of potential configurations of the industrial gas production complex superstructure;
specifying, in the model, a plurality of selectable modelled renewable power subsystems, each modelled renewable power subsystem having predicted time series power profile data for a predetermined time period associated therewith;
specifying, in the model, a plurality of selectable modelled plant subsystems, each selectable modelled plant subsystem having a plurality of selectable modelled components associated therewith;
associating a plurality of operational parameters and a plurality of operational constraints with each of the plurality of modelled renewable power subsystems, with each of the plurality of modelled plant subsystems and with the each of the plurality of selectable modelled components;
selecting a plurality of configurations of the model by selecting, for each configuration: one or more modelled renewable power subsystems; one or more modelled plant subsystems; and one or more components associated with the selected one or more modelled plant subsystems;
determining, for each selected configuration, the predicted operation of the selected configuration of an industrial gas production complex superstructure over a predetermined time period to determine a maximum value of a predetermined operational output parameter for the selected configuration and for the predetermined time period, the predicted operation utilizing the power profile data associated with the one or more selected renewable power subsystems and the operational parameters and operational constraints associated with the selected configuration;
utilizing a surrogate model to identify, based on the operational output parameter data and the selected configuration data for each configuration, one or more configurations of the industrial gas production complex superstructure operable to maximize the value of the operational output parameter whilst meeting the predefined operational constraints; and
generating one or more designs for the industrial gas production complex superstructure based on the identified one or more configurations.

19. A computer readable storage medium according to claim 18, wherein the plurality of selectable modelled renewable power subsystems is arranged in groups of: wind farm subsystems, solar farm subsystem, tidal power subsystems and hydroelectric power subsystems.

20. A computer readable storage medium according to claim 19, wherein within each of said groups a plurality of selectable modelled renewable power subsystems are available to be selected, each selectable modelled renewable power subsystem sharing the same profile of the predicted time series power profile data but varying in the magnitude of the available maximum power.
